(19) United States
(12) Patent Application Publication
(10) Pub. No.: US 2016/0055215 A1
(43) Pub. Date: Feb. 25, 2016

(54) Systems and methods of enabling integrated activity scheduling, sharing and real-time social connectivity through an event-sharing platform

(71) Applicant: Joseph Gregory Kauwe, Brooklyn, NY (US)

(72) Inventor: Joseph Gregory Kauwe, Brooklyn, NY (US)

(21) Appl. No.: 14/683,071

(22) Filed: Apr. 9, 2015

Related U.S. Application Data
(62) Division of application No. 14/463,627, filed on Aug. 19, 2014.

(51) Int. Cl. G06F 17/30; G06F 3/0482; G06Q 10/10; H04L 29/08

(52) U.S. Cl. CPC G06F 17/30528; H04L 67/18; H04L 67/306; G06F 17/30595; G06F 17/30554; G06F 17/30867; G06F 3/0482; G06Q 10/1095

(57) ABSTRACT

Embodiments herein provide for an interactive event-scheduling platform (ESP), wherein locating activities via location data, notifying and alerting of them via real-time feeds and encouraging interaction through a full-service social media suite (SMS), enhanced with live streaming and “always-on” connectivity, could provide a fresh experience for users and hosts. A real-time data procuring system and method may solve problems with stale or incomplete activity data within a geographic area, bridge gaps between users and hosts by shortening time periods—from activity announcement, to discovery, to launch, to action—create buzz, maximize venue attendance, boost sales and ensure promotional success. Software crawlers may mine public Web sites for thorough activity data coverage. Stored activities, profiles and collected user interaction data may produce behavioral reports to increase ROMI. Security packages, installations and access controls may incite users to safely register themselves in the SMS to engage, interact and transact.

### CROSS-REFERENCE TO RELATED APPLICATIONS

This divisional application claims the priority benefits of U.S. Non-Provisional application Ser. No. 14/463,627, filed Aug. 19, 2014, titled “Systems and methods of enabling integrated activity scheduling, sharing and real-time social connectivity through an event-sharing platform”, and U.S. Provisional Application Ser. No. 61/867,494, filed Aug. 19, 2013, titled “A Real Time Calendar Feed and Event-Scheduling Platform”, the disclosures of which are incorporated herein by reference.

### TECHNICAL FIELD

The embodiments herein relate to social media sharing platforms, particularly those that enable activity scheduling and interactive sharing during said activities, between users as peer consumers as well as interactive sharing between users as consumers and users as activity providers.

### BACKGROUND

Rapid technological advancements in telecommunications nowadays make it possible to instantly access the Internet, obtain information, find and consume services, attend or join activities and share nearly anything with anyone, such as activities, images, videos, opinions, thoughts and bookmarks using any web-ready mobile device such as tablets, digital cameras, digital recorders, body gear, consoles, terminals, drones, PDAs, laptops, computers or phones. Social media platforms are based on media created and disseminated by users through social interaction, which may be blogging, photo sharing, video sharing, product reviewing, and so forth. Social media and social network platforms and their applications make this real-time interaction easier by providing a central location of tools that make this happen, allowing various inter-relationships between users. Existing social network platforms connect users based on one or more specific types of interdependencies, such as friendship, family, interest, sexual orientation, social status, business relationships, and so on. Social networks however, are not generally based on connecting consumers and activities, and more importantly not connecting users with activities around the corner or in an unfamiliar town. With regard to events and activities, social media platforms may do better in not only influencing the way consumers behave, but how they interact as well. Using the feedback and information that these social media platforms manage to obtain on the activities they do collect, they affect user behaviors; so with the system and methods herein, users may select from a much larger, more enriched population of things to do of interest, stay connected with the activities that they might be enjoying regularly or might want to enjoy in the future, and interact with activity providers and other consumers.

A huge problem facing social consumers, entertainment enthusiasts, visiting tourists and bored consumers alike, is that a comprehensive source and simple process of locating upcoming activities, large or small, impromptu or one-time gatherings in a given area remains a challenge to this day. Whether it be a local movie night, a sale at a store, a farmer's market, a book club meeting, a grand opening at a restaurant, a rummage sale or local concert in the park, trying to discover something to do of interest can be frustrating. There are activity and event systems and publications available online and in print, but no single source is centralized and comprehensive. Existing sources are limited with sparse, “spammy”, stale, cherry-picked, or paid-only listings. As a result, in order to find out about activities happening in an area, one must stumble on them in newspaper listings, magazine sections, travel brochures, random flyers, TV advertising, radio advertising, word of mouth, local bulletin boards, online blogs, sparse media sources, or overhear it during casual conversation. The seemingly impossible task oftentimes results in an activity with no attendees, or worse yet, the discovery of an incredible event AFTER the date has passed, and the activity missed. FIG. 24A, Table 1 displays common event data sources currently used that may be replaced or supplemented by an event-scheduling platform.

With the growing popularity of social media interaction, consumers will continue to enjoy collecting images, amassing bookmarks, sharing discussions, creating music and video libraries, showing off an activity or location, and so forth, and there are many platforms to do this. There is no method, however that enables the collection of these items collectively as an activity or event “unit” or “entity” with cross interaction, for example, an instance where a blogger may be chatting with another user attending a seminar in another state, in real-time, discussing a slide show that a third user may be streaming from another room during a keynote speech, at the same seminar. The blogger may archive the entire interaction with all users including blogs, chats, slideshows, and speech transcript. FIG. 24B, Table 2 displays common sharing and archival methods currently used that may be replaced or supplemented by an event-scheduling platform.

Additionally, there are few, if any, mechanisms available for consumers to a) keep abreast and stay connected with all activities happening nearby, b) interact directly with activity providers, other users and even other attendees in real-time, through online tools in a way that fosters a new, unique shareable experience and c) instantly announce an activity for immediate consumption with global reach. An event-scheduling platform containing a social media suite may finally address these needs. Part of the reason for a disconnect occurring between users and unknown activities may be attributed to a limited and narrowed reach of activity promotion sources. Comprehensive activity listings are difficult to manage and obtain, due to a fragmented and selective collection process; so listings are cherry-picked, sparsely populated or reserved for higher ad payers and users see only a small portion of what is happening around them. Lack of new interactive experiences online can be attributed to existing social media platform tools and interfaces (Facebook®, Twitter®, LinkedIn®, Craigslist®, Yelp®, StumbleUpon®, Meetup®, Groupon®, GooglePlus®, Instagram®, Vine®, Tumblr®, Youtube®, Pinterest®, et al) being narrowed in scope and having limited, if any activity or event targeted functionality. None encourage users to get out of a residence to act. With regard to an ease of announcing and hosting an activity, none provide a simple or cost-effective, aggressive entry into an activity or event marketing and promotion space; and certainly none do it with a suite of tools, data object stores, image galleries, video libraries and live services that an event-scheduling platform provides. An event-scheduling platform paired with a social media suite may fill these voids if built with a core functionality that attaches each activity to a critical date parameter, to a location parameter, to user parameters, to data objects, to users and friends, forming permanent links between activities and users, creating “event entities” or “event units” that may have activity objects attached to them creating a massive activity-sharing network.

### SUMMARY OF THE INVENTION

The embodiments herein provide for an effective social network comprising a graphical user interface of an event-scheduling platform and social sharing system comprising methods, interactive tools and services that may incite a user or activity provider to act; attend or join an activity, post an activity, host an activity, share an activity or interact with someone who is—with each action enhancing an ever growing, dynamic and robust, activity related data store, data gathering, and social communication engine creating a new level of interpersonal relationships and new ways to experience life.

The invention is an interactive activity scheduling and sharing Web site—a social media system also serving a robust event-scheduling platform with up-to-the-minute activity listings tailored for a user. This dual purpose may enable actual participation in activities of which one would otherwise not be aware and enable interaction with other users at an activity or even those not in attendance, simultaneously. The event-scheduling platform may collect and disseminate activity data based on user-specific criteria such as location, interests or preferences. Based on said criteria, the platform may instantly search the database, alert, announce and display all tailored activities within a user specified radius, including in-process ones, anywhere at any time and engage a user to act. It may also bring the activity to other users via powerful elements of images, voice, live streaming video and video upload, key documents and schedules, maps and a myriad of sharing options to enhance an experience. The invention may disseminate live, current activity data to users for immediate consumption. Activities may be online activities or offline events. They may comprise a deep discount sale at store, a live concert in the park, a grand opening of a restaurant, the birth of a baby, a graduation party, a weather alert, a sports event, a farmer's market, a keynote speech at a convention, a chat session with a celebrity, a live stream of a show; it could be anything. Immediate access may allow for immediate reaction, response and may satisfy today's human need for instant gratification. This coupled with the ability to share content with groups of individuals across the globe with live video streams, images, comments, voice, as if they were actually attending or joining an activity, may serve as a powerful tool in marketing and mobilizing people for a common purpose. Individuals may become their own actors, bloggers, reporters, photographers, videographers, broadcasters and newscasters. The platform may facilitate adding an activity to a user's stored schedule, or export to other calendaring software systems off-platform. Finally, users may post their own special event or activity and record it in history as an activity collection with intimate perspectives—with video recordings and uploads, shared objects and files, real-time comments and interactions with other attendees documented, all of which may far exceed a collection of images in a picture book.

Activities are added for immediate consumption, live updating and live sharing continually. The collection of data may occur automatically by computer or by manual means,—collected automatically from public and authorized Internet sources or entered by a user or activity provider using import tools and forms on the platform for adding an activity. By tapping into an always growing, global activity database of real-time, constantly evolving data, users may access relevant activities that suit their needs at any hour of the day. Given that a user or activity provider may list their activities in a simple way, regardless of their entity size, the database may accumulate large budgeted or heavily advertised activities along with small, local ones and ensure a most comprehensive activity data set. Activity providers, large and small, may promote their up-to-the-minute activity to a global audience equally. Furthermore, an event-scheduling platform may provide a medium for review and feedback that could foster improvements in marketing and promotion to ensure future activity successes and in turn encourage more activities. The activity database may realize unlimited growth and have unlimited growth potential.

Technologies of a scheduling system and a social media platform may exist separately on popular Web platforms, but nothing exists that joins the two platforms to form a powerful activity-sharing suite. This invention may bridge that gap by bringing all activities to a user, displaying them in data point clusters around said user's chosen location on a map, including those that would have otherwise been unknown and engaging a user to act. Given this, users may plan their schedules more effectively, even in an unfamiliar city. The platform may allow activity goers and users to review, discuss an activity and simultaneously broadcast their experience, creating a new experience and in doing so provide invaluable input to the activity provider. The platform may show the overall effectiveness of a marketing campaign to activity providers, give valuable feedback of user consumption and help improve future activity or activity success. Few online media systems exist that can generate, as this platform may, significant amounts of foot traffic for small brick and mortar businesses to compete with larger businesses or online shops on a level playing field. An event-scheduling platform, with a social media suite of services may allow individuals, businesses and communities to market themselves through their activities, incite users to act, get users out of their homes and into their doors, bringing in much needed, foot-traffic and revenue. The invention may memorialize entire activities by providing a record of all objects, comments, images, video, chats and streams in ways that before didn't exist. The usefulness of the invention will vary from user to user and user as activity provider. The event-scheduling platform herein may relieve users of boredom, encourage users to be active, be social, travel, browse, shop, dine, live and share experiences. As activity providers, any individual, group or business that looks to increase foot traffic to their event may see it as a valuable marketing tool. Corporations and enterprises that require organizing and mobilizing groups around a time sensitive deadline to achieve a desired result or project deliverable (i.e., event promoters, travel coordinators, party planners, contractors) may find value in the invention.

The embodiments herein relate to a system and a method for efficiently mining, collecting, organizing, managing, storing activity data to a comprehensive database and disseminating said data within a framework that enables users to act, interact and transact; looking for activities in which to participate now or schedule to participate in later, or as activity providers looking for a means to promote, manage and store objects related to an activity for retrieval by other users. The system may include software designed for collecting and disseminating this information on various media devices, i.e. mobile phones, digital cameras, digital recorders, laptops, personal computers, body gear, ocular viewers, consoles, terminals, tablets, drones and any Internet-ready device. The system may make it easier for users to overcome the “fear” of missing out of an activity by having all activity happenings displayed on these devices on-the-fly. Moreover, the system may streamline procedural bottlenecks in the coordination and organization of these individual activity related tasks by having them accessible for updating in real-time by users, promoters and activity providers, thus keeping the activity data current, shortening time periods and maximizing attendance. The invention may also allow for the immediate sharing of itineraries, calendars and schedules through social media sources, links, interest boards, personal walls, tags, image photo streams, video galleries, interactive conversations, comments, posts and reviews.

The event-scheduling platform is comprised a graphical user interface designed specifically for viewing on mobile and non-mobile computing devices, i.e., mobile phones, laptops, personal computers, body gear, ocular viewers, drones, PDAs, consoles, terminals and tablets. It may also include a full, and always updating, commercial relational database engine for the storage of content and user inputted information and user-defined custom preferences and locations.

The event-scheduling platform may include annotation and indexing mechanisms which may simplify the collection, storage and management of critical activity data elements and uploaded objects, bring these user-defined items into the same searchable context as those that are inherently systemic and structured so that they may be indexed and matched for tracking, analyzing and disseminating results in a useful way—through mapping, calendaring, notifying, viewing, reporting, archiving and sharing.

The event-scheduling platform may include a mapping feature that may use stored data and display categorized activity data points or pins relative to a user's location, entered address and stored user-defined preferences or selected categories and filters.

The event-scheduling platform may use a notification system to alert the user or activity provider to upcoming activities, system emergencies, pending activities or approaching task deadlines, based on user-defined criteria via voice and text alerts, text messages, emails or notifications to an inbox. The system may also use a notification system to send activity reminders and follow-ups to users registered to receive them. The system may allow the user or activity provider to send invitations, annotations, tags, and comments to other users via the notification system.

The event-scheduling platform may include a software architecture comprising an event-scheduling platform that is further comprised three environments: a 1) social media presentation tier comprising a social media suite, an 2) advertising, content, device and management tier, a 3) relational database tier.

The event-scheduling platform may include additional tools for activity tracking and presentation, report generation, data analytics, trend analysis, statistical routines, security patches and installation packages.

The event-scheduling platform may have a universal browser-based presentation structure that may be scaled and deployed across various hardware resources and networks without a need to retool. It may be implemented on phones, laptops, tablets, optical viewers, body gear, drones, PDAs, consoles, terminals and personal computers by rendering the software at the non-mobile or mobile computing device level.

The event-scheduling platform may utilize widgets and plug-ins—blocks of programming code containing Web site functionality comprising Web services, Web API, SOAP, REST, JSON and XML real-time activity feeds—to collect, disseminate and share activity data. Widgets and plug-ins may be designed for embedding into off-site Web pages, emails and messages seamlessly to collect data, display schedules, calendars and maps and showcase featured activities.

### BRIEF DESCRIPTION OF THE ILLUSTRATIONS AND DRAWINGS

Other objects and advantages of this invention will become apparent to those skilled in the art upon reading the following detailed description of preferred embodiments, when read in light of the accompanying drawings wherein:

FIG. 1 illustrates a network incorporating an Event-Scheduling Platform (ESP), according to embodiments as disclosed herein;

FIG. 2 shows an ESP, according to embodiments as disclosed herein;

FIG. 3 shows communication links between the ESP interface and the user, according to embodiments as disclosed herein;

FIG. 4 illustrates an example user profile, according to embodiments as disclosed herein;

FIG. 5 illustrates an example login gateway, according to embodiments as disclosed herein;

FIG. 6A illustrates an example user initial access page before login, according to embodiments as disclosed herein;

FIG. 6B illustrates an example user initial access page after login, according to embodiments as disclosed herein;

FIG. 7A and FIG. 7B illustrate an example user initial access page in two scenarios, before login FIG. 7A and after login FIG. 7B, as viewed on a mobile device, according to embodiments as disclosed herein;

FIG. 8 illustrates an example search module and options, according to embodiments as disclosed herein;

FIG. 9 illustrates an import functionality between global and personal scheduling feeds, according to embodiments as disclosed herein;

FIG. 10 illustrates an example activity content page, according to embodiments as disclosed herein;

FIG. 11A and FIG. 11B illustrate an example activity content page, as viewed on a mobile device, according to embodiments as disclosed herein;

FIG. 12 illustrates an example activity-scheduling page in an activity management module, according to embodiments as disclosed herein;

FIG. 13 shows user-object relationships, according to embodiments as disclosed herein;

FIG. 14 shows a notification flow, according to embodiments as disclosed herein;

FIG. 15 shows an example RSVP system page, in an activity management module, according to embodiments as disclosed herein;

FIG. 16 shows an example notification system page, in an activity management module, according to embodiments as disclosed herein;

FIG. 17 illustrates an Initial Access, according to embodiments as disclosed herein;

FIG. 18 illustrates an Access As User Flowchart, according to embodiments as disclosed herein;

FIG. 19 illustrates an Access As Activity Provider Flowchart, according to embodiments as disclosed herein;

FIG. 20 illustrates a Content Module Flowchart, according to embodiments as disclosed herein;

FIG. 21 illustrates a Search Module Flowchart, according to embodiments as disclosed herein;

FIG. 22 illustrates an Add/Edit Activity Flowchart, according to embodiments as disclosed herein;

FIG. 23 illustrates a table comprising sample database, indices, and primary key assignments, according to embodiments as disclosed herein; and

FIG. 24A and FIG. 24B display replaced or supplemented, common sources table (FIG. 24A) and replaced or supplemented common archiving mediums table (FIG. 24B), according to embodiments as disclosed herein.

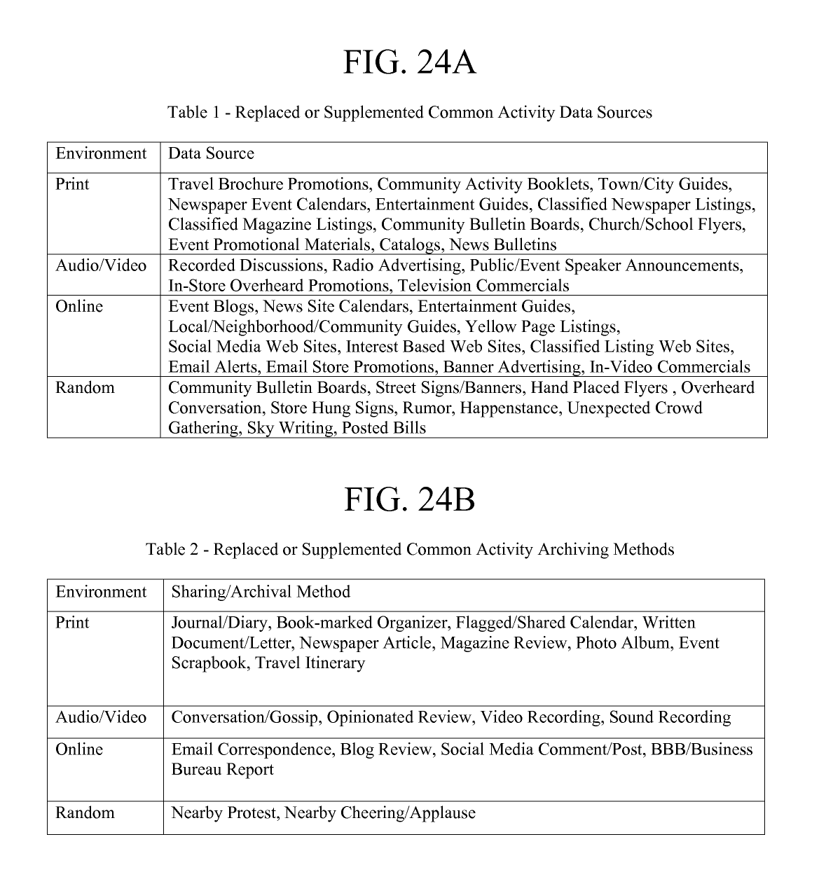

### DEFINITIONS

user—For the purposes of this specification and the associated claims, the term “user” is used to reference the Event-Scheduling Platform (ESP) account owner, such as an individual, consumer, group, closed user group, user-agent, automated agent, corporate or a commercial entity.

activity, event, activity database records—For the purposes of this specification and the associated claims, the term “activity”, “event” and “activity database records” are used interchangeably to reference a happening and the related data records that are associated with it, such as an offline or online activity, streaming activity, non-streaming activity or recorded activity; which may consist of a performance, alert, broadcast, announcement, commercial event, sale event, open house, recorded audio, recorded video, fund-raiser, conference, political event, discussion, interview, auction, book-signing, lecture, lesson, natural disaster, emergency, flash mob, accident, prank, sports activity, family gathering, get-together, party, celebration, memorial, assembly, protest, meeting, to-do item, task, contract deadline, reservation or appointment. The activity may also be categorized into multiple different categories, such as entertainment or ceremonies and subcategories assigned thereof such as concert or wedding. Activities, events and activity database records may also refer to a collection of sub-activities, sub-events and sub-activity records, that make up an overall activity, event or activity database record. For example, a corporate conversion from one operating system to another operating system may comprise a collection of project phases (i.e., data mapping, testing) that too, are comprised smaller activities, each of which needs to be completed before the overall conversion activity is completed.

activity provider—For the purposes of this specification and the associated claims, the term “activity provider” is used to reference a user operating in a “point-person” capacity such as a moderator, team leader, host, manager, dispatcher, director, organizer, planner, promoter, coordinator, facilitator, instructor or point of contact for an activity.

place or venue—For the purposes of this specification and the associated claims, the terms “place” and “venue” are used interchangeably to reference physical locations, such as restaurants, theaters, stadiums, office, ballroom, conference room, or places of business, among others. A place or venue will have various attributes or features, such as a physical location, category and hours of operation, among others. The place or venue may also be categorized into multiple different categories, such as restaurant or Italian restaurant.

location—For the purposes of this specification and the associated claims, the term “location” is used to refer to a geographic location, such as a longitude/latitude combination, zip code or a street address.

real-time—For the purposes of this specification and the associated claims, the term “real-time” is used to refer to calculations or operations performed on-the-fly as activities occur or input is received by the operable system. However, the use of the term “real-time” is not intended to preclude operations that cause some latency between input and response, so long as the latency is an unintended consequence induced by the performance characteristics of the machine.

on-the-fly or ad-hoc—For the purposes of this specification and the associated claims, the term “on-the-fly” and “ad-hoc” are used interchangeably to refer to an action that is performed at a moments notice, on demand, with little planning or forethought, for example a last second search for “chef appearances” for a special surprise night out, or a report to generate how sudden weather changes are affecting a crowd gathering.

off-platform or off-site—For the purposes of this specification and the associated claims, the term “off-platform” and “off-site” are used interchangeably to refer to instances, occurrences or objects that are not within the framework and environment of the Event-Scheduling Platform (ESP) as outlined herein.

on-platform or on-site—For the purposes of this specification and the associated claims, the term “on-platform” and “on-site” are used interchangeably to refer to instances, occurrences or objects that are within the framework and environment of the Event-Scheduling Platform (ESP) as outlined herein.

widget or plug-in—For the purposes of this specification and the associated claims, the term “widget” and “plug-in” refers to a snippet or block of software code that may be copied and embedded, or “plugged”, into other Web pages, media, emails, interfaces or applications easily, and may utilize a Web API (i.e., XML, JSON, REST, SOAP) or Web services structure to enable a live connection that may refresh on its own, or each time a page or screen is accessed or refreshed. For example, a calendar widget may be embedded into an email so that current activities happening around a reader are displayed whenever the email is read.

### DETAILED DESCRIPTION OF THE PREFERRED EMBODIMENTS

The embodiments herein and the various features and advantageous details thereof are explained more fully with reference to the non-limiting embodiments that are illustrated in the accompanying drawings and detailed in the following description. Some descriptions of well-known components and processing techniques are omitted so as to not unnecessarily obscure the embodiments herein, for example a “log out” button which may always be accessible from any page of the Web site, may not be disclosed in every embodiment or drawing. Similarly, because users may also be activity providers, access to management modules may be accessible from every page of the Web site, even though it may not be illustrated or apparent in some of the embodiments or herein. The examples used herein are intended merely to facilitate an understanding of ways in which said embodiments might be practiced and to further enable those skilled in the art to practice the embodiments herein. Accordingly, the examples should not be construed as limiting the scope of the embodiments herein.

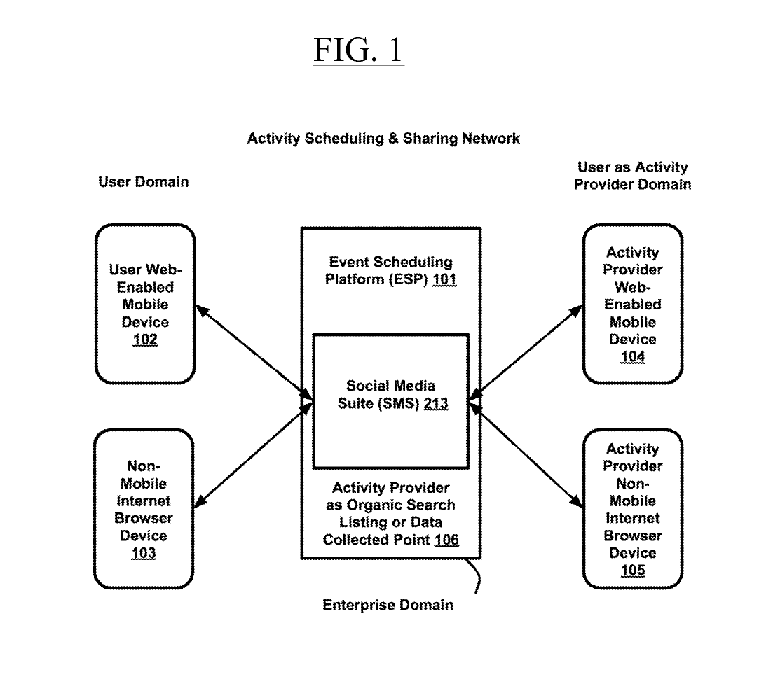

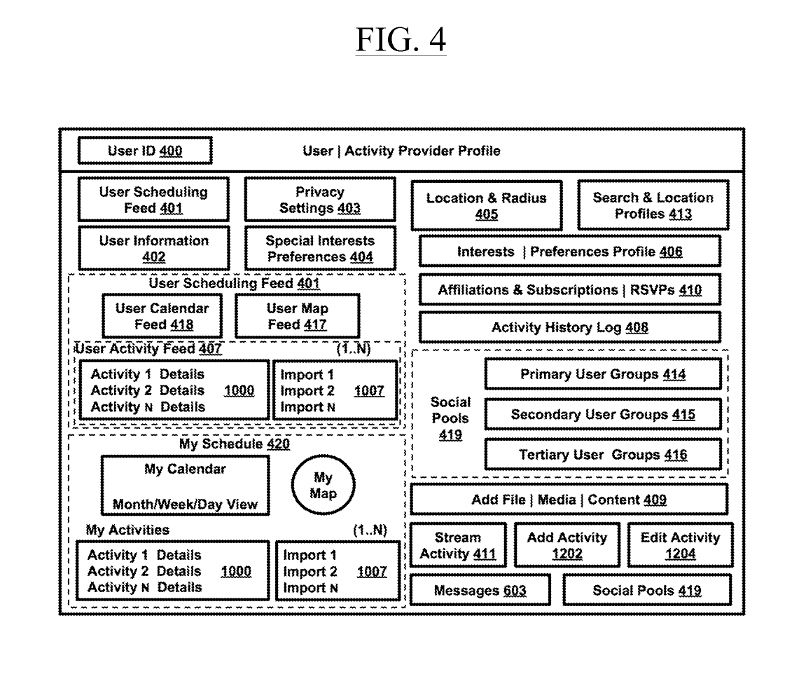

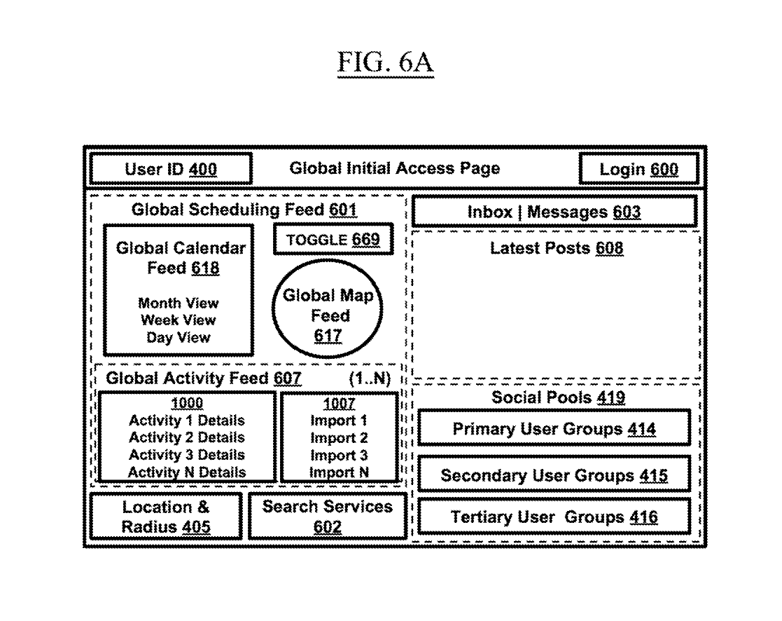

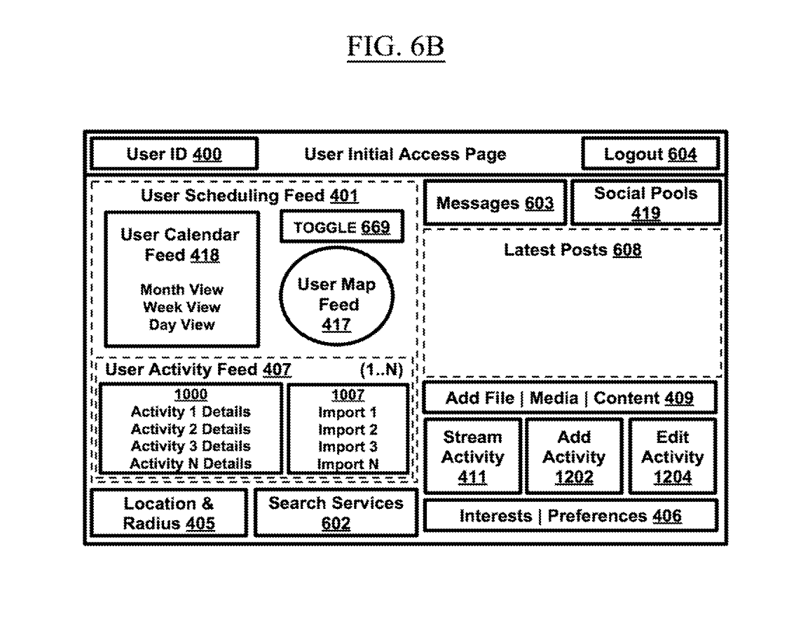

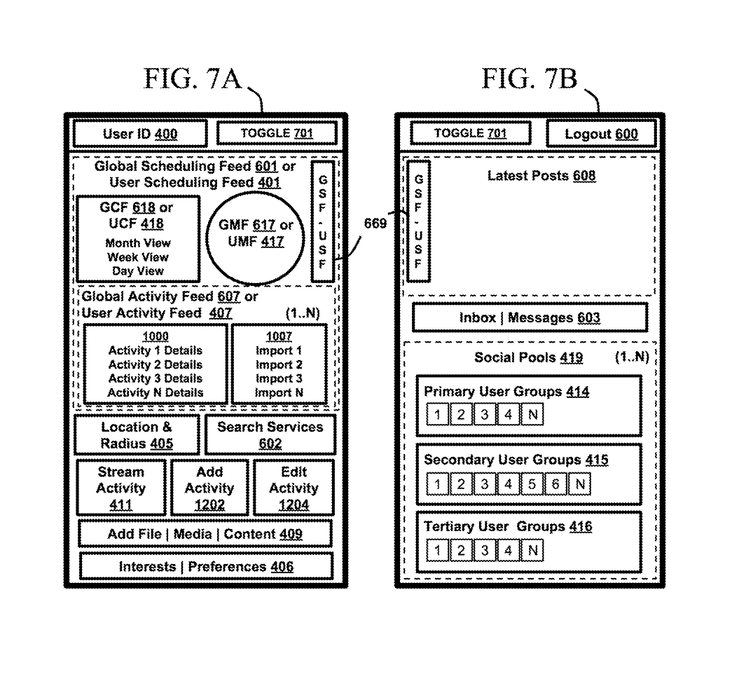

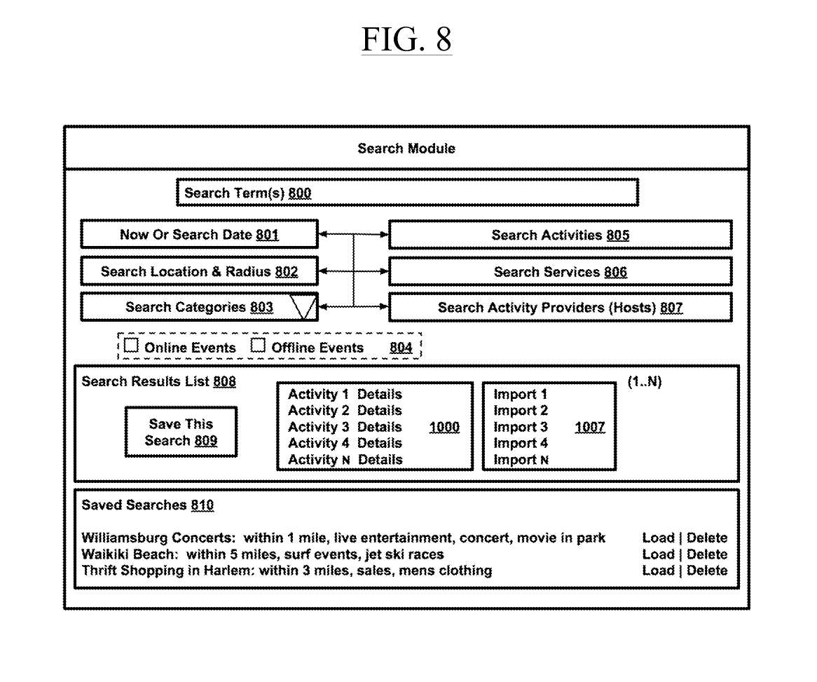

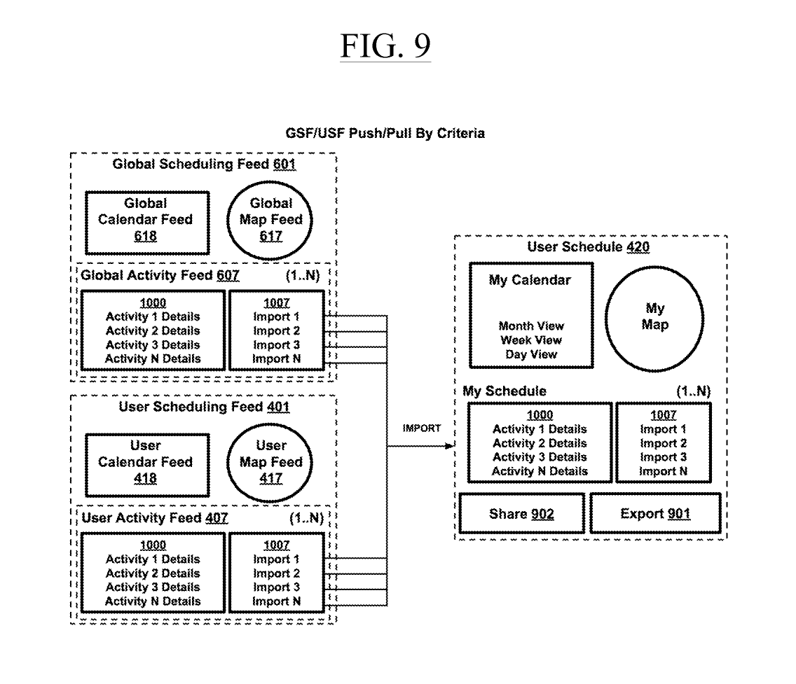

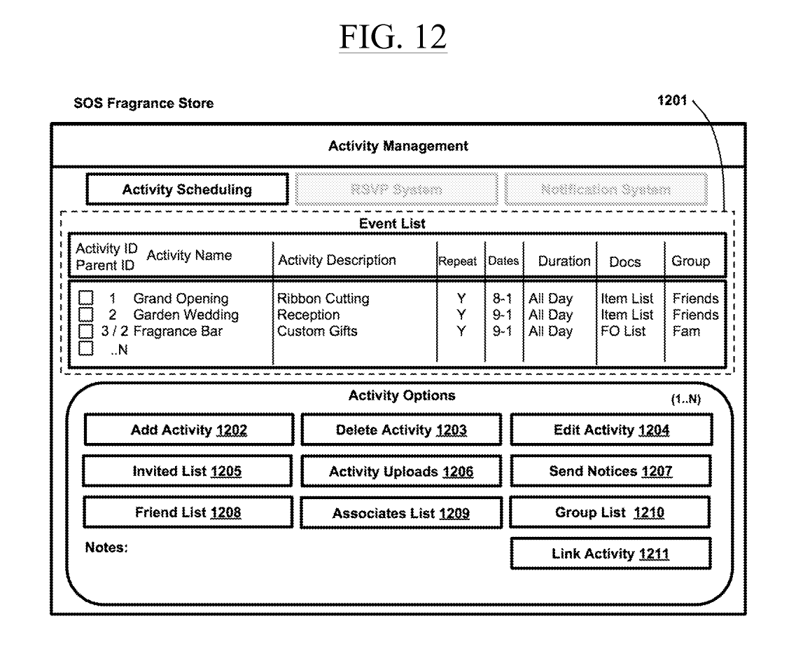

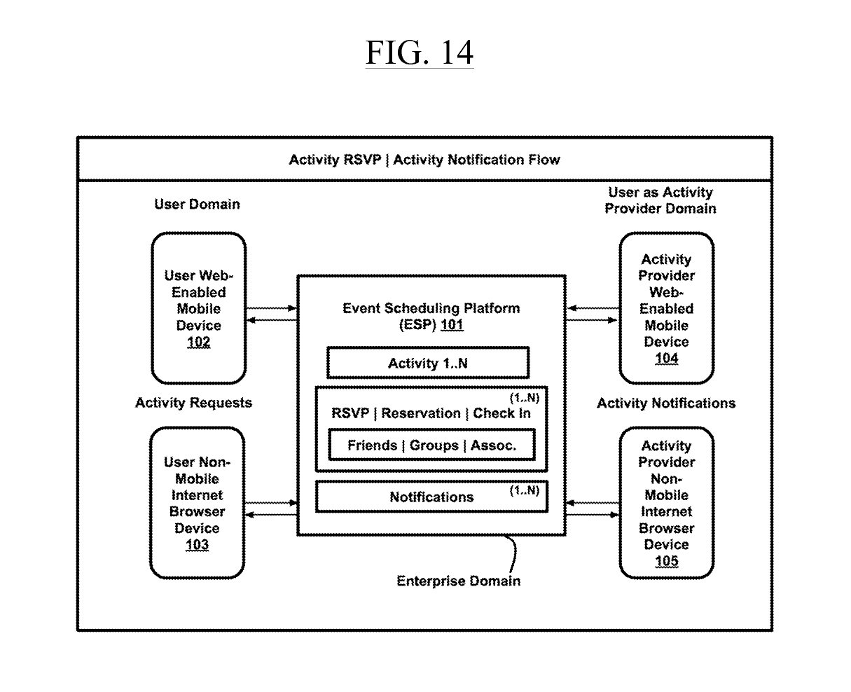

The embodiments herein disclose a system for permitting Internet and mobile Internet users to access Internet resources, social media services and activity schedules and calendars more efficiently. Regarding the drawings, and more specifically to FIGS. 1 through 16, where similar reference characters denote corresponding features consistently throughout the figures, there are shown embodiments. Further regarding the drawings and embodiments herein, and more specifically to FIG. 4, FIG. 6A, FIG. 6B, FIG. 7A, FIG. 7B, FIG. 8, FIG. 9, FIGS. 12-16, a list of items may be depicted as a collection or summation Σ of N activities where N begins at 0 and is incremented by 1 for each item until all items have been counted and a final item is reached with the Nth item being the last item. For example, item 1, item 2, item 3, item 4, . . . item N. In these embodiments, each item within a set of N items, may stand mutually exclusive from the others, or may together comprise a relationship set of N items, or a subset of relationship items from N population of items with other mutually exclusive items therein. For example, a list may comprise N related activities, with all activities together comprising one complete activity set that comprises N activities.

### System Embodiments

FIG. 1 depicts a network incorporating an event-scheduling platform according to embodiments as disclosed herein. It shows an overview between the Event-Scheduling Platform (ESP) 101 and activity providers and users. The network comprises an ESP 101 at the center of a network bridging users in a user domain 102 & 103 and an activity provider domain 104 & 105. A user domain and an activity provider domain may be connected to the ESP 101 using Web services, Web API or any other suitable communication means such as a mobile network. The network may be accessed using non-mobile or mobile computing devices, protocols and services to facilitate interaction and access to it through static and dynamic Web pages via browsers, software clients, mobile applications and so forth. User and activity provider domains may be one in the same, since a user may also act as an activity provider. Users may be any individual, sole proprietor, vendor, group or business entity such as a restaurant, corporation, music band, theater, salon, contractor, service provider, neighborhood store, and so on. An activity provider may reside entirely in an enterprise domain as a listing retrieved from a public or authorized Web site through a Web search or manual data collected entry process 106. A user or activity provider domain further comprises an access means such as a mobile device 102 & 104 or a Web browser based console 103 & 105. Domains may access the ESP 101 using a mobile device 102 & 104 using any equipped Internet connection means, such as 3G, 4G, LTE, GPRS, EDGE or any available Internet access means. Users and activity providers may also access the ESP 101 using a Web console 103 & 105 from a browser and computer, handheld device, tablet, etc. Web consoles 103 & 105 may connect to the ESP 101 using any available Internet connection means such as a wireless network, a wired network, LAN, VPN, a dial-up connection and so forth.

The ESP 101 provides a graphical user Web interface comprised a Social Media Suite (SMS) 213, which allows mobile and Internet users or groups to access platform services and utilize them as deemed appropriate. The SMS 213 may enable users and activity providers to register, log in, find and post activities and events. The system may house information provided in a database, index records based on parameters, categorize them and display results according to consumer specific variables. Parameters may be static, like interest categories, address, size, or other such configurable parameters, or dynamic such as GPS location, capacity levels, wait times, or the weather. These parameters combined with user input, keyword search parameters allow for optimally matched results to be provided instantly. The ESP 101 may also use unique individual identifiers, or keyword entries, such as a popular name of the activity, or user or activity provider name (to locate a particular host, for example), that a user provides to help with a primary search in accordance with stored search parameters deemed appropriate for ease of quick decision making, such as locations nearby or activities happening now, and make those search options available for use in said user's profile permanently, by importing them into their schedules and stored in said user's preferences.

The ESP 101 via the SMS 213 may emulate existing features of similar social media applications, an ability to discuss, review, comment, share and upload media files, images and video with an added utility to stream live data with any non-mobile or mobile computing device. The ESP 101 however, may allow users and activity providers to link media of their choice, such as images, drawings, graphics, sound clips, music, video, live streams, documents, products lists, menu items, and so on, to an activity, so that they may be instantly viewed by a consumer and shared across the ESP 101 for promoting an identity, image, product, activity or event. The user or activity provider may share activity information data items on a per item basis and select or configure particular users or groups whom to target, giving certain users access permissions to view, comment, share or download. A user or activity provider may upload said activity data objects through the ESP 101 with smart tags, keywords, categories, location information so that users may access, view, interact and act on immediately.

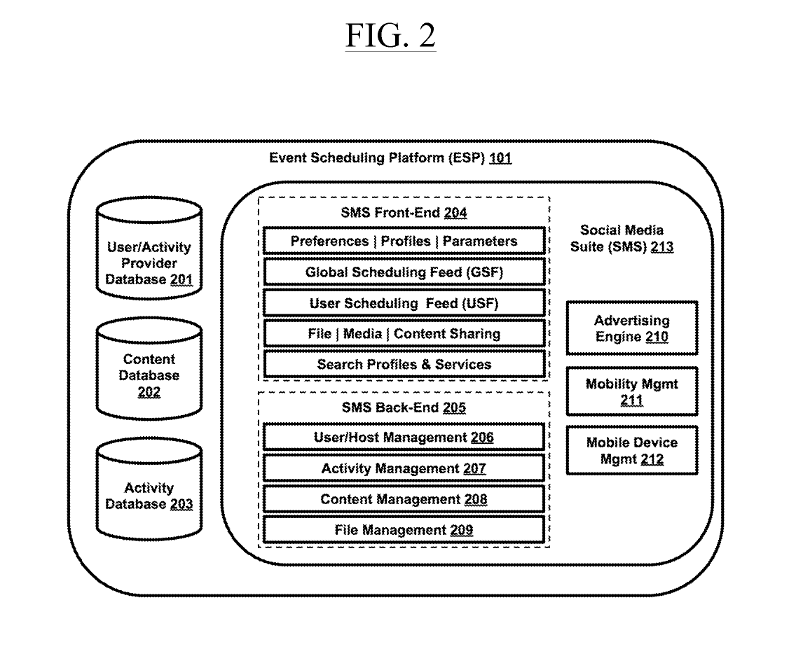

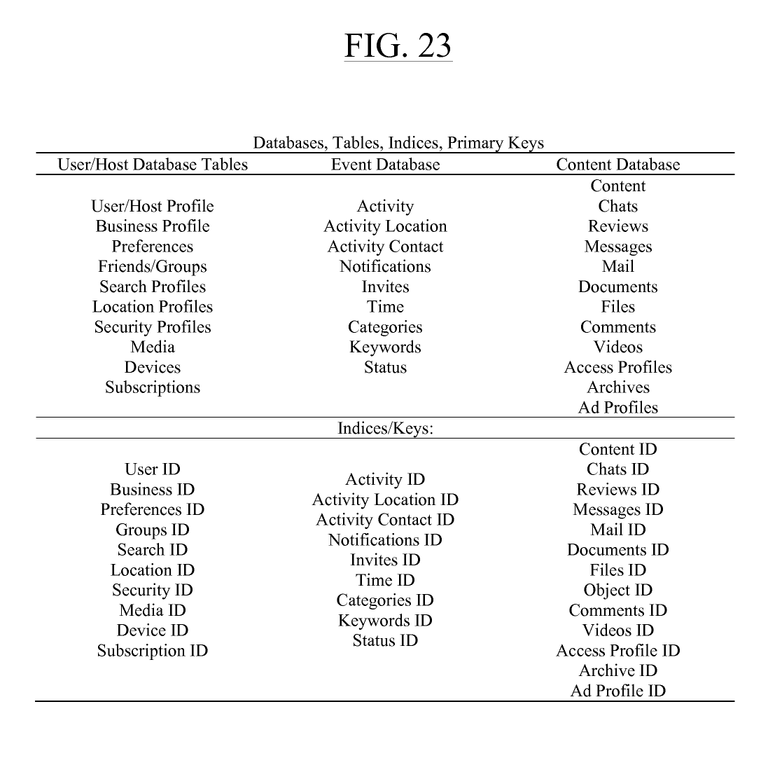

FIG. 2 illustrates an event-scheduling platform according to the embodiments as disclosed herein and illustrates the enterprise environment that makes up the invention. The ESP 101 comprises a user or activity provider database 201, a content database 202, an activity database 203, an advertising engine 210, a mobility management engine 211, a mobile device management engine 212, and an SMS 213 comprising a front-end 204 and a management back-end 205. The front-end of the SMS 213 comprises modules described later in the user embodiments section, further comprising user preferences, parameters and profiles, global scheduling feeds, user scheduling feeds, file and media sharing modules and search engine and search profiles. The back-end of the SMS 213 comprises a user or activity provider management module 206, an activity management module 207, a content management module 208, and a file management module 209. Example main tables, indices and primary keys are shown in FIG. 23.

The ESP 101 is a combination of powerful software interfaces, scheduling feeds and an SMS 213, to create a robust scheduling and activity-sharing system. It may provide users with immediate access to activities happening in an area, given data stored preferences their profiles. Upon setting up an account, a user may enter vital pieces of information, such as age or favorite hobby, which may be used as parameters for returning relevant data to said user. Because this happens continuously at the ESP 101 through a continuous connection between users and the SMS 213, a user or activity provider may access activity information instantly via a non-mobile or mobile computing device and find an activity happening at anytime, anywhere. Not only may a user attend or join an activity, which may be a live concert, a sale at a store, a streamed event, or something happening around the corner, it may allow for immediate sharing with others, even other attendees, with plug-in capabilities to interact with one another at the SMS 213 via a chat box, peer to peer messaging systems, SMS messaging, on-platform software clients or with other third party Web tools. The platform may also be a powerful marketing tool for activity providers so that they may make announcements instantly to users, of activities to attend or join, warnings to heed, or services to consume.

The Domains

A user or activity provider domain may comprise Web enabled and computing devices further comprising computers, laptops, terminals, consoles, body gear, ocular viewers, digital cameras, digital recorders, drones, PDAs, tablets or mobile devices via an application interface. Communication between the ESP 101 and a user or activity provider may occur on a browser console or computer by means such as a wireless network, a wired network, LAN, VPN, a dial-up connection and so forth, a mobile device via any equipped Internet connection means, such as 3G, 4G, LTE, GPRS, EDGE or any available Internet access means, and with continued connectivity through various protocols comprising Web services, Web API, feed protocols, on demand by user or on-the-fly, real-time with location services so that said user is continually updated.

The Databases

Data is continually collected and may be stored in 3 main databases, a user or activity provider database 201, a content database 202 and an activity database 203. A user or activity provider database 201 may house basic profile information of a user, special interests, preferences, privacy settings, etc. A content database 202 may contain comments, files, media, blogs, ads, etc. An activity database 203 may contain activity data collected, dates, times, duration, etc. The databases are the primary sources of data, items and objects presented on the platform.

The ESP 101 may store information about a user or activity provider in a user or activity provider database 201, comprised a user name, nickname, business name, residential address, business address, occupation, hobbies and interests. A user or activity provider database 201 may contain both static and dynamic data, interest and search parameters and may be a repository capable of persistent storage and long term archiving. A user or activity provider database 201 may contain a user location, friends and group affiliations, setting of privacy and preferences, a record of activities attended, location profiles, search profiles, interest profiles, activity profiles and histories of activities involved. A user or activity provider database 201 may also have an ability to store commerce related data, such as services consumed or provided, occupancies, capacities, products purchased or offered, menus, maps, marketing materials and activities attended. A content database 202 may store content related to users, posts, reviews, conversations, documentation, media files, as well as advertisements, promotions and announcements related to businesses and their offerings. An activity database 203 may contain information pertaining to activities themselves such as dates, times, attendance, invitations, notifications sent/received, and admission costs, invitation lists, product lists, reviews and ranking data, along with other static and dynamic data such as location, capacity levels, rain-dates, duration, etc. Activity data may be collected by various methods comprising a user inputting activity data manually, automated bots mining public or authorized Internet sources, a user importing activities from off platform sources, third party services allowing such discovery using Web services or Web API (i.e., SOAP, JSON, REST, XML) or on-platform widgets installed on third-party sources collecting and forwarding activity data back to the platform.

The SMS Front-End Interface & Feeds

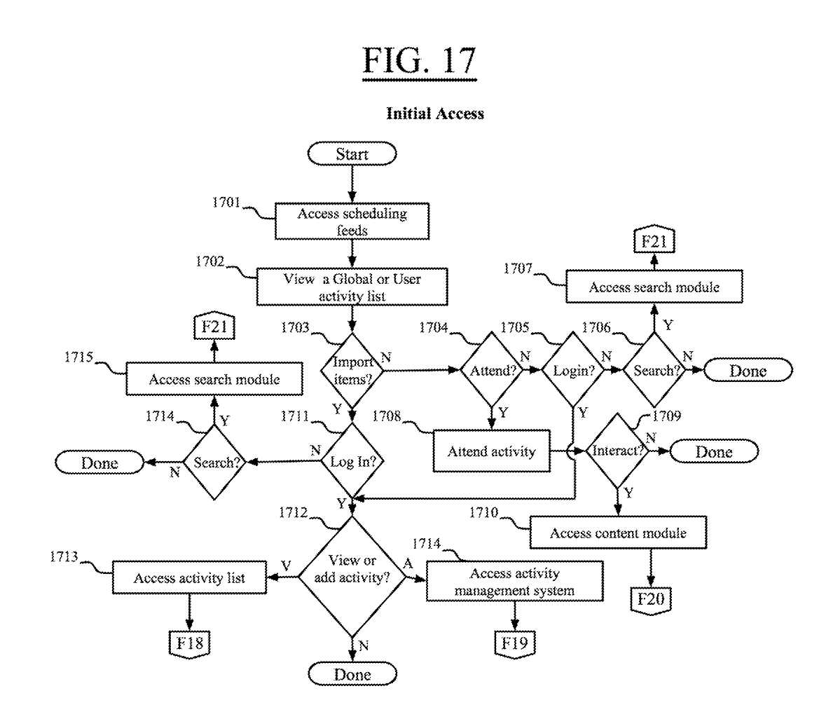

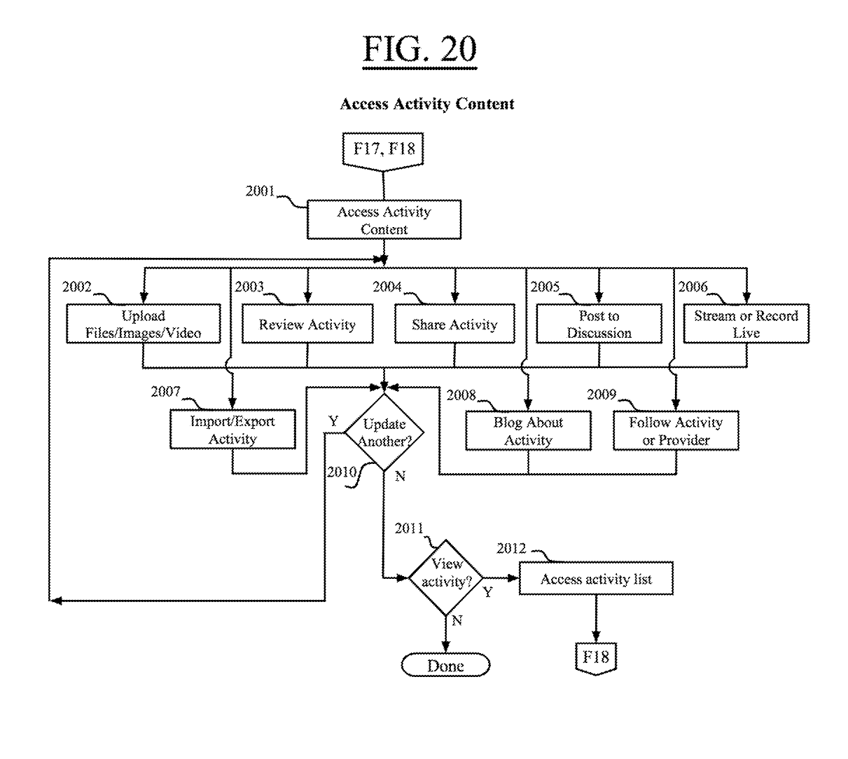

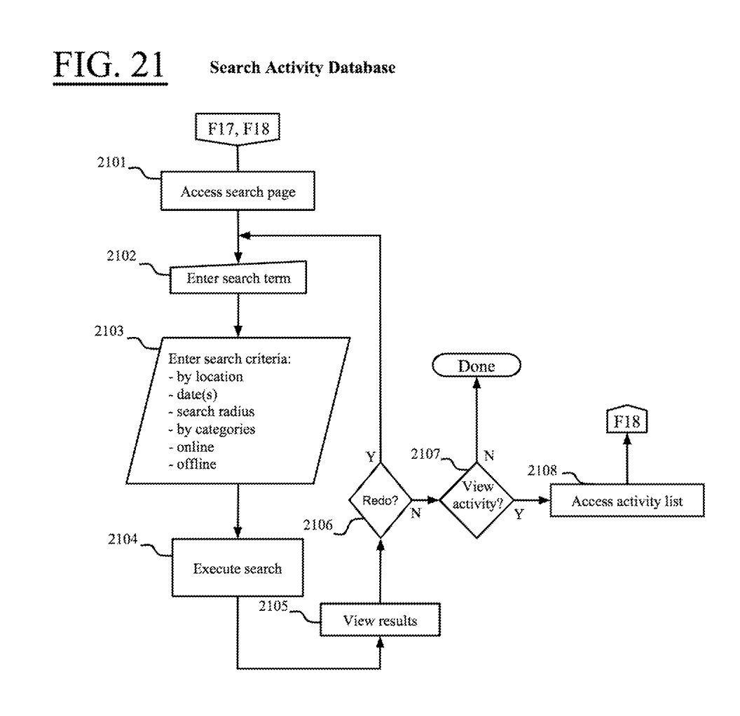

The SMS 213 front-end 204, global scheduling feeds and user scheduling feeds may access activity data records stored in databases to present relevant activity data to a user through a graphical user interface, collection of tools and on-platform resources, allowing users to customize browsing experiences, interact with others, transact with activity providers and assemble groups for gathering, all in real-time. A featured component of the front-end Web-interface SMS 204 may be a global scheduling feed and a user scheduling feed, which may announce activities happening in an area. A global scheduling feed may be a presentation of activities without any filters, except for that of location, so that every activity in an area is listed. A user's location and radius may be changed at any time to show different results. A user scheduling feed may be a customized subset of a global schedule of activities, accessed and filtered upon signing into the SMS 213, filtered by user-defined parameters, interests and various other criteria. Included flowcharts illustrate sample uses of the front-end Web interface SMS 204. FIG. 17 shows an initial access to the platform prior to a user logging in or accessed after logging in, where a user may simply browse activities in the global scheduling feed and decide if anything happening at that moment is worth attending or joining, or do a search as illustrated in FIG. 21. If there is any activity of interest, a user may view details, attend an event and choose to import an activity into a user schedule along with storing preferences that exists for that activity in a user profile, so that similar activities may be incorporated into future scheduling feeds. If there is none of interest, then a user may log in to the platform and see if there are any personalized activities worth attending or joining. While at an activity, a user may interact, stream an activity live, upload images, post comments, review an activity, and so forth, as illustrated in FIG. 20.

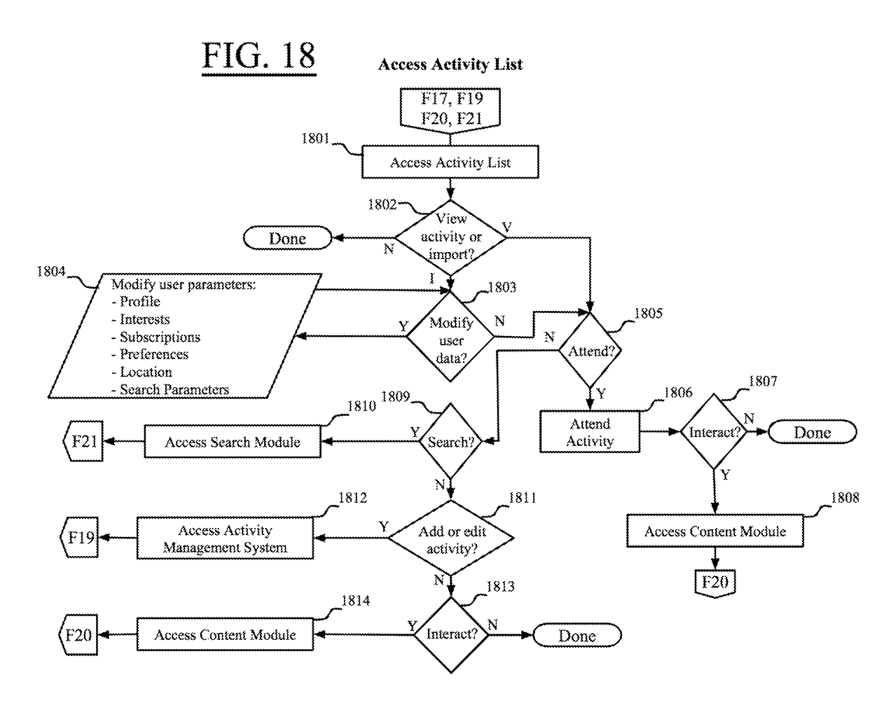

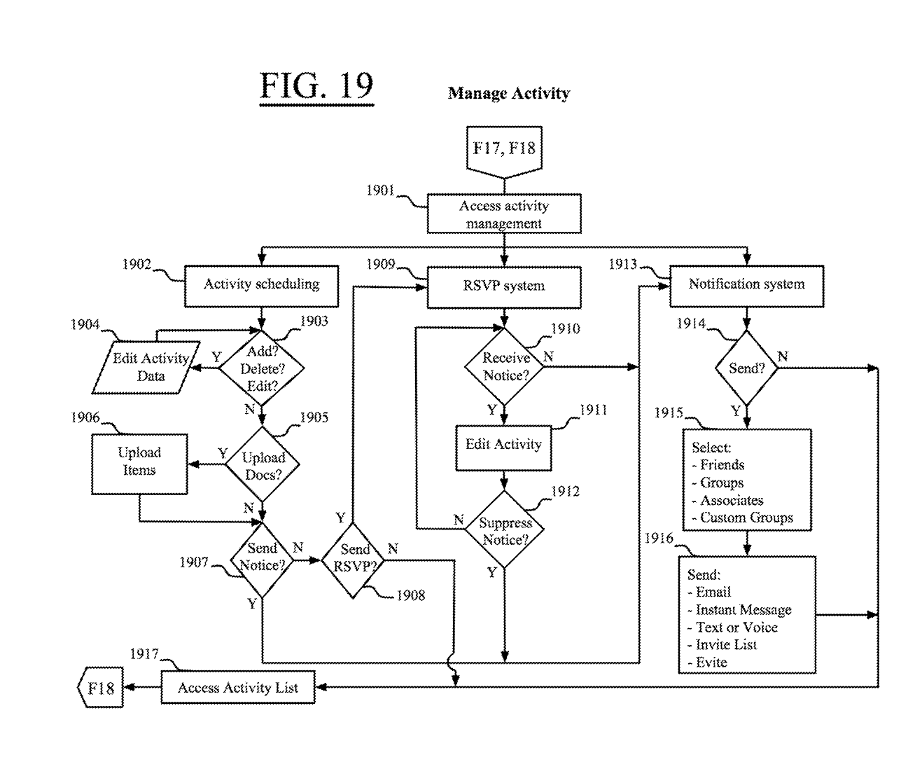

Logging into the Web site, a user may sign in as a user as shown in FIG. 18, or activity provider as shown in FIG. 19—with a different sequence of pages presented during a browsing experience. Access site pages for a user may be geared toward finding an activity to consume or interact with others online, whereas access site pages for an activity provider may be geared toward adding or managing an activity. FIG. 18 may show a flow as a user after logging in and accessing a main user profile page on a Web console or a condensed access page on a mobile device—where a user may view activities in a user scheduling feed, toggle to and from a global scheduling feed, import activities respectively, comment on activities, interact with primary friends and groups, extended friends and groups and associates, check mail, upload files, stream an activity live, modify account information as shown in FIG. 20 or search for activities as shown in FIG. 21. On a mobile device, due to screen size, content may be split and a mobile toggle may exist to flip from scheduling feeds to posts and back again. There may be another toggle to flip between a global scheduling feed and a user scheduling feed; both toggles are detailed later in the user embodiments section. Importing activity details from a global scheduling feed or user scheduling feed into a user's schedule may allow copying preferences, keywords, categories and so forth, to a user search profile, so that similar activities would be displayed in a user scheduling feed going forward. At any point during or after an activity, users may rate an activity, venue, activity provider, entertainment, etc. which may be useful to other users in evaluating future activities of said activity or said activity provider.

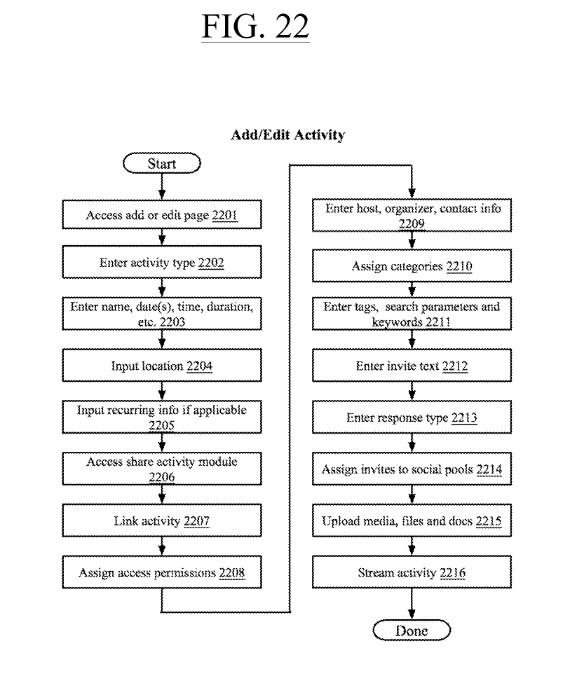

A user signing in as activity provider as shown in FIG. 19 may be presented with an activity management system 207 and be able to view current activities that are set up, add, modify, delete an activity as shown in FIG. 22, upload items for an activity such as an agenda, menu, product list, directions, coupons, etc. and/or send notices to invitees. A user may access an RSVP system to review existing notices on a per activity basis, invites, correspondence that have been sent, such as RSVP's, reservations and headcounts, and an ability to suppress or resume notices, for example if an event is nearing capacity. A user may access a notification system which collects responses in a mailbox utility, compose or resend letters, decide on how messages are to be sent, i.e., by email, fax, text, voice, letter, and so forth, and then may assign friends, groups or associates lists as recipients.

The SMS 213 front-end 204 may present real-time scheduling feeds, facilitate in-line collaboration, manage and share user data and objects. The SMS 213 front-end 204 is responsible for user management, activity management, group collaboration, activity search and other functions performed by the ESP 101. The SMS 213 front-end 204 may also track user movement and update said user's location in a user database 201 in real time. It may also allow a user to create closed user groups or create custom groups for sharing and interacting. A closed user group or custom group may be people with a commonality, for example, with similar interests, business associates, same school, or related in a familial way. The SMS 213 front-end 204 may also provide privacy tools for users to control access to certain areas of said user account and content.

At any moment, a user may perform detailed searches, querying the databases accordingly. A search engine may enable a user to search for a user, activity or activity provider based on several parameters for an immediate call to action. Parameters used to search for a service may comprise an activity category, location of a user, location of an activity, date and time of an activity, a particular activity provider, activity reviews, popularity of activity providers, services, or activities. A search module depicted in FIG. 21 shows options that a user may use to find activities around which to plan, attend or join. A search may also enable a user to locate online activities as well as offline activities, such as a webcast, webinar, live feeds, online sales, and so on, to attend or import to a user schedule. A powerful ability to customize searches by saving preferences, keywords, categories to a user search profile, so that similar activities would be displayed going forward in a user scheduling feed, may enable a user to store multiple search profiles to further enhance a browsing experience.

The SMS Back-End & Management

The SMS back-end 205 and management engines 210-212 contain management utilities 206-209 of the enterprise so that current, relevant content and services may be offered to users. It may contain administration functions, repositories and dedicated modules to make this happen by controlling content, providing notification tasks, sending auto-responders, maintaining activity data records, providing mailing functions, executing security modules, storing recovery tools, testing environments, documenting policies and procedures, performing behavioral and trend analytics and serving advertisements relating to activity providers.

The advertising engine 210 may intuitively stream context based or paid advertisements to a user based on preferences entered during registration, interests in said user's profile, current search context, search history and other criteria to display targeted advertisements. A content management module 208 may interface with an advertising engine 210 to retrieve data from a content database 202 to make this happen.

The mobility management module 211 may manage the mobility of individual users, plurality of users as groups, location of static as well as mobile activities. A mobility management module 211 may provide location related algorithms in order to compute a location of an activity with reference to a group of users or a single user, or users relative to each other.

The mobile device management module 212 provides device management capabilities to render and support adaptive content to a plethora of mobile device types, models, platforms, protocols, and so forth, used by a user or activity provider to access the ESP 101. Such devices may be any non-mobile or mobile computing device comprising tablets, smart phones, laptops, ocular viewers, consoles, terminals, drones, PDAs, video recorders, mobile cameras and body gear.

The activity management module 207 allows users, and users as activity providers to perform activity coordination, scheduling and management within a single user or a multiple set of users connected logically or at least registered with the SMS 213. An activity management module 207 may provide an ability to synchronize global scheduling feeds and user scheduling feeds within a mobile device or console to update activities that were created or modified by users. An activity management module may allow users to create, modify, delete activities, find other users with whom to interact, stream and share objects. The ESP 101 may disseminate activity information over the Internet via the SMS 213 to other users for immediate consumption and engage interaction. For example, live document sharing may be used in an office meeting, one-to-one video may be used for interviews, a one-to-many video activity may be set up for a lecture or class or a many-to-many video may be set up for a teleconference.

The content management module 208 provides a management engine that may house and retrieve user content comprising consumer reviews, media files, press releases, images, documentation, promotional materials and advertisements related to activity providers 104, 105 in a content database 202. A content management module may provide software for recording, storing and retrieving activity data and access repositories with protocols for sharing and streaming media, such as SIP, RTP, RTMP with video encoding capabilities for standard definition, high definition, and for voice over IP and video control signaling.

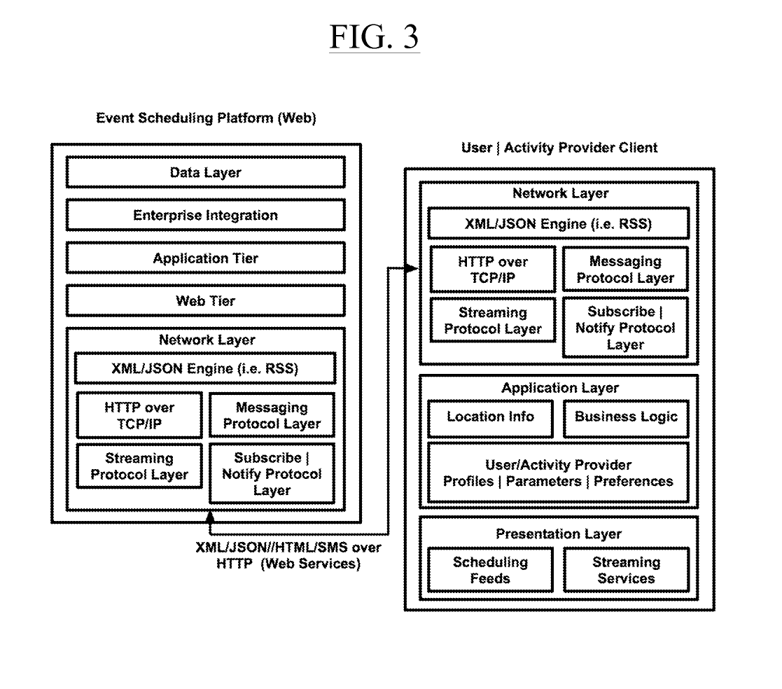

FIG. 3 depicts a communication implementation between the ESP 101 and a client (a non-mobile or mobile computing device or a console) according to embodiments disclosed herein. It shows communication protocol layers that may exist between the ESP 101 interface and a user. A communication implementation between a client and ESP 101 may be based on activity-driven, or notification-based interaction patterns, which are commonly used patterns for inter-object communication and syndication. Examples exist in many domains, for example in publish/subscribe systems provided by message oriented middleware vendors, or in system and device management domains. This notification pattern is increasingly being used in a Web services context as well. WS-Notification is a family of related white papers and specifications that define a standard Web services approach to notification using a topic-based publish/subscribe pattern. It includes standard message exchanges to be implemented by service providers that wish to participate in point to point notifications, standard message exchanges for a notification broker service provider (allowing publication of messages from entities that are not themselves service providers, i.e. third party feeder systems, third party marketers), operational requirements expected of service providers and requestors that participate in notifications, and maybe be of an XML (i.e., RSS) or JSON model that describes topics of subscription. In an example environment, a client and ESP 101 may provide JSON and XML engines and implement existing standard Web service specifications for inter-communication and syndication. For the purposes of the embodiments disclosed herein, a syndicated service may be an “always on” or “always available” streaming communication between the ESP 101 and a user or activity provider through the SMS 213 via global scheduling feeds 601 and user scheduling feeds 401 comprising activity feeds, calendar feeds and mapping feeds, so a user may stay abreast of what is happening in an area.

### User Embodiments

FIG. 4 shows a typical user profile, as may be viewed on a client like a Web browser on a non-mobile or mobile computing device, according to the embodiments as disclosed herein. It illustrates an example user profile page for updating interests, preferences, characteristics, and so on. A user or activity provider profile comprises a collection of user information, contacts and preferences where a user may customize their browsing experience. A user or activity provider profile comprises a User ID 400, a USF 401, user information 402, privacy settings 403, special interests and preferences 404, user location 405, with location being either dynamic (GPS) or user entered, an interests and preferences profile 406, a UAF 407, activity history and archive 408, a file, media, content container 409, a subscriptions and following area 410, a stream activity live module 411, an add an activity module 1202, an edit an activity module 1204, saved searches and saved locations 413, a friends and associates social pools module 419, comprising primary (i.e., close or familial) friends and groups (PUG) 414, secondary (i.e., casual or extended) friends and groups (SUG) 415 and tertiary (i.e., professional) associates and groups (TUG) 416, a UMF 417, a UCF 418, a user's schedule 420, and a message and email receptacle 603.

The user ID 400 is assigned at a time of registration and is used to access the ESP 101 and is a primary index for joining data across databases and tables along with an activity ID.

The USF 401 comprises three elements: 1) a list of tailored upcoming activities UAF 407, 2) a corresponding plotted interactive map UMF 417 and 3) a corresponding calendar UCF 418, and may highlight all activities surrounding a user, so that an immediate decision to interact, attend or join an activity may be made. On an interactive map UMF 417, a user may click a plotted activity on said map to view activity details. Similarly, on a calendar UCF 418, a user may click to view activities by day for easier scheduling and click on an activity in a list UAF 407 for details and calls to action, with links to view date(s), time(s), duration, related documents, details, category, rating, reviews of an activity and/or activity provider along with links to other activity specific information. A user may also import 407 an activity to a user schedule 420 in their profile. A USF 401 may use information stored in a user profile as its main source for parameters used to dynamically generate customized activity lists. A USF 401 is comprised activities present in a database that are auto-filtered based on user-defined preferences. A list of activities may be of anything, sales, ceremonies, speeches, announcements, meetings, parties or group activities. Any changes made by a user to a profile, interest, location, etc. on-the-fly may be instantly reflected in an activity list generated by a USF 401. Activity information in a USF 401 is also stored as a part of a user profile and indexed with an activity ID. Since activities may be common to multiple users, activity related information may be stored separately in a cache, a cookie, or in an archive and history, but references to them may be made available to a user profile, objects or sessions. Exchange of information between the ESP 101 and GSF/USF scheduling feeds and a user may happen using a Web services or Web API notification architecture.

The user information 402 comprises information of a user, such as a real name of a user, nickname, age, gender, marital status, phone number, etc. Some elements of user information 402 may be optional for a user. Privacy preferences 403 may enable a user to indicate how much personal details should be publicly visible. A user may also set how another user or activity provider may contact said user. For example, a user may want to hide a real name and address, but want to keep age and gender public. A user may utilize special interests and preferences 404 to narrow interests or store interest stacks, for example a user may be interested in watching movies, eating out and shopping all as a “set” of activities done in one day. Advertisements to a user may be tailored according to interests as indicated by said user. Location and radius 405 may be a dynamic field and may be updated with a location of a user and stored in terms of mapping coordinates (latitude and longitude). A location 405 may also be stored as a physical address, in terms of a street and area, manually entered. A location may also be stored with respect to a plurality of cellular base stations. A location 405 may be an element and via a location ID assigned per user, used to generate data feeds to a USF 401 continuously by area as well as integral in returning search location based search results. It is a key index to saving location search information on a per area basis in a user saved search/saved locations profile 413 discussed a bit later in this figure.

The history and archive 408 is a module that may track and store history of attendance, interactions, chats, posts, bookmarks and archive online navigation trails for retrieval later. A user history and archive 408 may store previous attendance and associated interactions of a user that occurred that day surrounding an activity. This field may be configurable by a user. For example, a user may want to store their history for the past two weeks or past twenty days only, or save portions of an activity, such as a video feed only, or posts only and decide which to share and which to keep private. In history and archive 408, a user may access activities created by said user or activities that a user attended even when created by others, along with any interactions that happened, conversation, chats, messages, video, etc. A user may also delete items from a repository if desired. A user content bin 409 is a storage area, where a user may store media indefinitely. Media may be videos, pictures, text, blogs, documents, marketing materials or any other media, and may be linked and indexed by activity ID and may be shared with others within a social network. A user may also configure settings so that media from an activity is shared with only a specific individual, group or those in a subscriptions/following area. This may happen on a per activity basis via unique activity IDs. A user may also assign permissions for sharing on a per item basis. A subscriptions/following area 410 may comprise other users, activities, topics, and so on, in which a user has found some interest, subscribed to and/or follows to keep abreast of their activity. A stream activity live 411 module may enable users to stream video live through the ESP 101. A user may add an activity 1202 and in doing so assigning an activity ID to said activity. An add activity function is shown in FIG. 22 and may be performed in an activity management module.

A user may have multiple locations and search profiles and save them for easy retrieval later. For example, a user may save key search parameters, one of them being by location and radius, so if a user was in Honolulu, a user could have a wide default search parameter set to locate activities, and a smaller one set for bustling New York City. Similarly, a user may have several location profiles 413, for default location references during login. For example, a user visiting Paris could have the ESP 101 respond in every aspect with that location at its zero point, friend lists reshuffled, search profiles reshuffled, and so forth.

A friend and associates pools module 419 offers a user quick access to user groups associated with said user account, so that peer interaction may take place, i.e., sharing files, chat sessions, one to one video, one to many video, emailing, messaging, SMS texting, chatting, and so forth, using third party software tools or tools available on the ESP 101. A friend and associates pools module 419 comprises primary (i.e., close or familial) friends and groups (PUG) 414, secondary (i.e., casual or extended) friends and groups (SUG) 415 and tertiary (i.e., professional) associates and groups (TUG) 416. A user may create custom groups, which may have a common factor, for example, a group may comprise friends of a user who went to college, while another may comprise associates from work and yet another may be a members of a user's family. Primary (i.e., close or familial) friends and groups (PUG) 414, extended (i.e., casual or extended) friends and groups (SUG) 415, tertiary (i.e., professional) associates and groups (TUG) 416 and subscriptions/following area 410 may make up a user's interactive social pools 419.

At any time in a browsing experience, a user may add an activity 1202, delete an activity 1203 or edit an activity 1204. A user schedule 420 may display activities that a user has added or imported into their schedule, listed in an orderly date and time format. It may comprise activities imported from a GSF 601, imported from a USF 401, imported from search results 502, imported from off-platform calendars or manually added by a user 1202. A user may export an activity from their schedule to an off-platform schedule, calendar or device, for example to a Google calendar or mobile phone calendar.

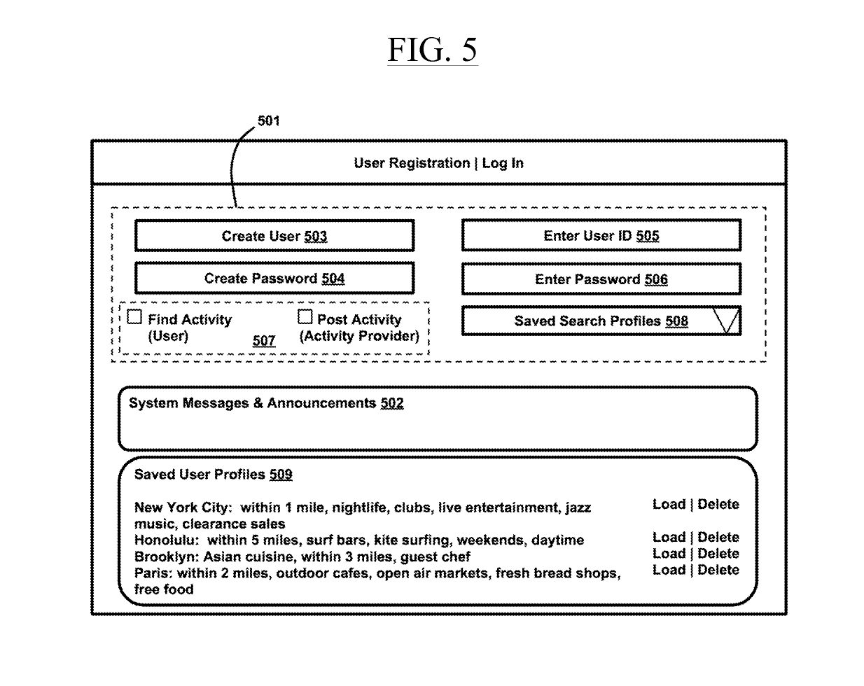

FIG. 5 displays a registration/login page, as may be viewed on a client like a Web browser on a non-mobile or mobile computing device, according to the embodiments as disclosed herein. It illustrates an example login gateway where users may opt to sign in as user or activity provider, and load saved profiles. During a user or activity provider registration/login 501, a quick view of any system messages, alerts, miscellaneous platform specific news and announcements may be displayed in a system messages area 502. Users may create an account 503. New or existing users may modify an existing password 504 and following reset steps therein. Existing users may log in to the ESP 101 with a user ID 505 set up during a registration process and corresponding password 506. A user may opt to access an account as a user or activity provider by ticking an appropriate box 507. A user may also log in with a prior, user saved location profile using a location profiles dropdown box 508 pre-loaded with user saved profiles or by clicking an option in a detailed saved location profiles 509 section. If logged in as a user, said user may land at a user screen depicted in FIG. 6, if logged in by a Web console or web-ready computer, or if by a web-ready mobile device, a condensed screen as in FIG. 7. If logged in as activity provider, another sequence of pages may be presented—beginning with an activities maintenance area in a management console FIGS. 12, 15 and 16. Regardless of whether a user is logged in as an activity provider or as a user, throughout an entire browsing experience, same screens may be accessible and permissions are mirrored, however a sequence of navigation may differ. Same permissions may be given to both user and activity provider, so anyone may view an activity and anyone may post an event. Same data structures may exist for individuals as it does for businesses, contractors, artists, or anyone with a need to organize an activity. Enhancements for custom commercial, activity planning features and other sample uses are noted in the Alternative Embodiments section below to outline specific interface access permissions on a per user or group basis.

A key functionality of a login page is an ability for a user or activity provider to sign in with a saved location profile by selecting a profile in a location profiles dropdown list 508 or by selecting one from a list of saved location profiles 509. A user may have several location profiles saved for default location points of reference during a login. For example, if a user was in Paris, said user could have the platform respond in every aspect with that location at its zero point, friend lists reshuffled, search profiles reshuffled, etc. Any auto-assigned location setting may be overridden by a selected location. A new set of browsing parameters may be viewed and loaded because of assigned location IDs stored within the database from prior searches and visits.

FIG. 6A and FIG. 6B are of two access homepages with a toggle between them, as may be viewed on a client like a Web browser on a non-mobile or mobile computing device, according to the embodiments as disclosed herein. It illustrates an initial access Web page before and after login, highlighting a functioning toggle button that may allow users to switch between a global scheduling interface and a user scheduling interface. FIG. 6A and FIG. 6B are of a GSF 601 and USF 401 together, showing that a user may click between the interfaces seamlessly with a GSF/USF toggle 669, and how activity data in a GSF 601, USF 401 and respective posting areas 608 are affected appropriately as described below.

FIG. 6A depicts an initial access page, as may be viewed on a client like a Web browser on a non-mobile or mobile computing device, according to various embodiments herein. It illustrates an initial access Web page of the platform prior to a user logging in, which may include an activity feed list, appropriately date highlighted calendar, and appropriately plotted map of all activities within a central, device generated GPS location. An initial access page may be seen when the platform is accessed with every new session prior to logging in or seen when a user logs out. Its main focus is on a live, at-a-glance view of activities available, with a global scheduling feed (GSF) 601 which comprises 3 elements: 1) a list of upcoming activities in a global activity feed (GAF) 607, 2) a corresponding plotted, interactive global map feed (GMF) 617 and 3) a corresponding global calendar feed (GCF) 618 to highlight all activities surrounding a user, so that said user may make an immediate decision to log in 600 attend an activity, interact, or join an activity. On an interactive map GMF 617, a user may click on a plotted point to view activity details. On an activity calendar GCF 618, a user may view activities by day, week, or month for easier scheduling, and an activity list GAF 607. Clicking a live activity link anywhere on a GSF 601 may present activity details and calls for action as in the list 1000, with options to view date(s), time(s), duration, related documents, details, category, rating, reviews of an activity and activity provider along with links to other activity specific information, and offer options of reviewing, discussing, sharing, rating said activity and an activity provider. A user may also have an option of importing 1007 an activity to a schedule 420 in their profile along with activity parameters, discussed a bit later in this description.

The activities displayed may be presented based on a central location and a radius parameter, which may be edited dynamically using a user location and radius link 405. A central point may be an automatic triangulated GPS location of a user's mobile device, or a manually entered location by a user as an address, zip code, latitude/longitude coordinates, a stored profile favorite location or a location from a prior session visit. A radius search parameter may be selected from among varying radii (e.g., 1 mile, 5 mile, 10 mile), or a stored profile radius preference from a prior session visit. A user may also allow access permissions to said user's location, giving access to the public, to a closed user group(s), or to specific users.

Revisiting an import feature, a key functionality of an activity listing may be an ability to import 1007 any activity displayed from a GAF 607 into a user's schedule 420 or update preferences in their profile accordingly. After selecting an activity 1000, a user may specify if basic information comprising—name, date, time, location—are to be imported or if all its search parameters are to be saved to a user's profile, so that similar activities are added to a USF 401 ongoing, i.e., a search radius, a specific category or categories, a specific activity provider, and so on.

Along with aforementioned features, a keyword search 602 and a display of latest live posts and comments 608 relating to upcoming activities increase the invention's functionality. At any time, a user may search for specific activities 602 based on search criteria offered by a search module FIG. 8, such as location and radius, category, activity provider, etc. as illustrated in FIG. 21 on-the-fly and import activity results from a search result list presented. A scrolling chat box of posts 608 from users in an area discussing activities reflected in a GSF 601, offer a user an arena for discussing related activities. A chat box of posts 608 may include a steady flow of comments pertaining to activities displayed in a GSF 601, either by a default settings database call, or an on-the-fly search that a user has performed using static and dynamic parameters comprising said user's search parameters, and reflects in real-time, whatever posts are occurring for whatever activities are shown in a GSF 601.

If a user is logged in, a friend and associates pools module 419 may display offering a user quick access to contacts and user groups associated with said user account, so that peer interaction can take place, i.e., sharing files, chat sessions, one to one video, one to many video, messaging, SMS texting, chatting, and so forth, using third party software tools or tools available on the ESP 101. A user may also check messages and emails 603. A friend and associates pools module 419 comprises primary (i.e., close or familial) friends and groups list (PUG) 414, secondary (i.e., casual or extended) friends and groups list (SUG) 415 and tertiary (i.e., professional) associates and groups list (TUG) 416.

A user may use a toggle feature 669 to flip between a global access page FIG. 6A and a user access page FIG. 6B.

FIG. 6B depicts an initial access page, as may be viewed on a client like a Web browser on a non-mobile or mobile computing device, according to various embodiments herein. It illustrates an initial access Web page of the platform after a user logs in, which may include a customized activity feed list, appropriately date highlighted calendar, and appropriately plotted map of all activities within a central user-defined location. A user initial access page is a first page seen after a user logs into the platform and contains all activity related content and options with respect to said user's preferences. Its main focus is on a live, at-a-glance view of activities available, with a user scheduling feed (USF) 401 which comprises 3 elements: 1) a list of upcoming activities in a user activity feed (UAF) 407, 2) a corresponding plotted, interactive user map feed (UMF) 417 and 3) a corresponding user calendar feed (UCF) 418 to highlight all activities surrounding a user, so that said user may make an immediate decision to log in 600 attend an activity, interact, or join an activity. On an interactive map UMF 417, a user may click on a plotted point to view activity details. On an activity calendar UCF 418, a user may view activities by day, week, or month for easier scheduling, and an activity list UAF 407. Clicking a live activity link anywhere on a USF 401 may present activity details and calls for action as in the list 1000, with options to view date(s), time(s), duration, related documents, details, category, rating, reviews of an activity and activity provider along with links to other activity specific information, and offer options of reviewing, discussing, sharing, rating said activity and an activity provider. A user may also have an option of importing 1007 an activity to a schedule 420 in their profile along with activity parameters, discussed a bit later in this description.

The activities displayed may be presented based on a central location and a radius parameter, which may be edited dynamically using a user location and radius link 405 and various parameters unique to each user, i.e., interests, history, etc., which too may be edited dynamically using a preferences and interests profile 406. A central point may be an automatic triangulated GPS location of a user's mobile device, or a manually entered location by a user as an address, zip code, latitude/longitude coordinates, a stored profile favorite location or a location from a prior session visit. A radius search parameter may be selected from among varying radii (e.g., 1 mile, 5 mile, 10 mile), or a stored profile radius preference from a prior session visit. A user may also allow access permissions to said user's location, giving access to the public, to a closed user group(s), or to specific users.

Revisiting an import feature, a key functionality of an activity listing may be an ability to import 1007 any activity displayed from a UAF 407 into a user's schedule 420 or update preferences in their profile accordingly. After selecting an activity 1000, a user may specify if basic information comprising—name, date, time, location—are to be imported or if all its search parameters are to be saved to a user's profile, so that similar activities are added to a USF 401 ongoing, i.e., a search radius, a specific category or categories, a specific activity provider, and so on.

Along with aforementioned features, a keyword search 602 and a display of latest live posts and comments 408 relating to upcoming activities increase the invention's functionality. At any time, a user may search for specific activities 602 based on search criteria offered by the search module FIG. 8, such as location and radius, category, activity provider, etc. as illustrated in FIG. 21 on-the-fly and import activity results from a search result list presented. A scrolling chat box of posts 608 from users in an area discussing activities reflected in a USF 401, offer a user an arena for discussing related activities. A chat box of posts 608 may include a steady flow of comments pertaining to activities displayed in a USF 401, either by a default settings database call, or an on-the-fly search that a user has performed using static and dynamic parameters comprising said user's search parameters, and reflects in real-time, whatever posts are occurring for whatever activities are shown in a USF 401. A user may add 1202 or edit an activity 1204, upload files, documents, videos and images to a repository 409 and stream live content 411 for sharing.

A friend and associates pools module 419 offers a user quick access to user contacts and groups associated with said user account, so that peer interaction may take place, i.e., sharing files, chat sessions, one to one video, one to many video, messaging, SMS texting, chatting, and so forth, using third party software tools or tools available on the ESP 101. A user may also check messages and emails 603. A friend and associates pools module 419 comprises primary (i.e., close or familial) friends and groups list (PUG) 414, secondary (i.e., casual or extended) friends and groups list (SUG) 415 and tertiary (i.e., professional) associates and groups list (TUG) 416.

The user may use a toggle feature 669 to flip between a global access page FIG. 6A and a user access page FIG. 6B.

FIG. 7A and FIG. 7B are of two access page views as may be rendered on a mobile device, with two toggle tabs, as may be rendered for viewing on a non-mobile or mobile computing device, according to the embodiments as disclosed herein. FIG. 7A and FIG. 7B illustrate a GSF/USF toggle 669 and a mobile/widget toggle 701 as described. A user may flip between a user scheduling feed 401 and a global scheduling feed 601 interface seamlessly with a GSF/USF toggle 669, and respective components comprising activity feeds 407/607, map feeds 417/617, calendar feeds 418/618, posting areas 608 are affected and displayed appropriately.

FIG. 7A is an access page viewed after logging into the ESP 101 as may be rendered for viewing on a non-mobile or mobile computing device, and may be a condensed version of a Web site access pages, FIG. 6A and FIG. 6B. To accommodate a smaller screen, a second mobile/widget toggle 701 may allow a user to flip to a second screen, FIG. 7B and back again to FIG. 7A. FIG. 7A comprises a scheduling feed among other options and FIG. 7B comprises corresponding user posts relating to said scheduling feed in FIG. 7A, among other options. An initial access mobile/widget view may be of either a USF 401 or GSF 601 and may have the same functionality and content as a Web browser access pages, FIG. 6A and FIG. 6B. A user may view activity details 1000 and import items 1007 to a personal schedule 420, search with parameters, location, radius, etc. 602 or load a prior location or search profile 413, and import 1007 to a personal schedule 420 from those results. A scrolling chat box 608 as in FIG. 7B may show latest, real-time posts and comments displayed relating to a results set of activities provided by scheduling feeds, filtered by user-defined settings, activity preferences and other user-defined parameters. A user may add 1202 or edit an activity 1204, upload files, documents, videos and images to a repository 409 and stream live content 411 for sharing.

A friend and associates pools module 419 offers a user quick access to user contacts and groups associated with said user account, so that peer interaction may take place, i.e., sharing files, chat sessions, one to one video, one to many video, messaging, SMS texting, chatting, and so forth, using third party software tools or tools available on the ESP 101. A user may also check messages and emails 603. A friend and associates pools module 419 comprises primary (i.e., close or familial) friends and groups list (PUG) 414, secondary (i.e., casual or extended) friends and groups list (SUG) 415 and tertiary (i.e., professional) associates and groups list (TUG) 416.

The user may use a toggle feature 669 to flip between a global access page FIG. 7A and a user access page FIG. 7B.

FIG. 8 is a search module, as may be viewed on a client like a Web browser on a non-mobile or mobile computing device, given various embodiments herein. It illustrates an example search module and search options, and an option to save a search. FIG. 21 illustrates a search module flowchart. A user may search for activities collected and input manually, retrieved from automated bots mining public Internet sources, a user importing from off platform sources, from third party services that allow such disclosure using Web services or Web API (i.e., SOAP, JSON, REST, XML) or retrieved by on-platform widgets installed on off-platform sources or embedded in off-platform content, emails or listings. A user may control activities being searched in various ways, such as limiting results to local activities or those centered within a specific area by radius, address or zip code 802. A user may also restrict activities to a particular category by choosing category or tags 803, by a keyword search in a text box 800, or by date or date ranges 801. A user may also choose to search by a user name or activity provider name 807 or narrow a search by online activities or offline activities 804, just search activities 805 or just search services 806. After selecting options, submitting a form may yield activity results 808 comprising an activity name, date, time of an activity along with a rate or review option and an ability to import an item into a user's schedule 420, along with saving its preferences to a user profile, if desired, to customize future search results. A user may save search 809 parameters and store search term combinations that have been used for future searches. If, for example a search yielded particularly good results, a user may wish to save it for ease of access later. Any combination of selections may be used and saved in a search profile for future access and saved search results 810 may be loaded, if desired. This may particularly be useful for different cities, to enable custom profiles to feed useful information on a per area basis. In various embodiments, a search database at the ESP 101 may be indexed with registered information by various search providers as well as index data made available by several third party business listings, reviews, blogs, activity listings or phone directories through Web services, Web API feed type services. For example, search data may be indexed by activity name, activity category, activity location, price and rating along with discussions imported from Twitter®, among other key search terms aforementioned.

FIG. 9 illustrates the dynamic nature of a push/pull feature according to embodiments as disclosed herein. It illustrates sample interactive relationships between global schedules, user schedules and personal schedules. A push/pull functionality between a GAF 607/UAF 407 and a user schedule 420 may offer an ability to import and merge selections from scheduling feeds to an individual schedule 420 along with parameters assigned to it, providing a personalized browsing experience as a tailored activity information resource. When clicking an import tab 1007, a user may be presented with options to select one or more parameters tied to that activity to be imported with it to be saved in a user profile. For example, if a live music concert a block away in the neighborhood park is listed with free admission, a user may import said event into their schedule and parameters associated with said event. So, any offline, live music event, within a one-mile radius of said user, with free admission, may be appended to an already existing, stored search profile for that user if desired. A user may also export 1008 an activity or the entire set of activities 901 to an off-platform or off-line calendar.

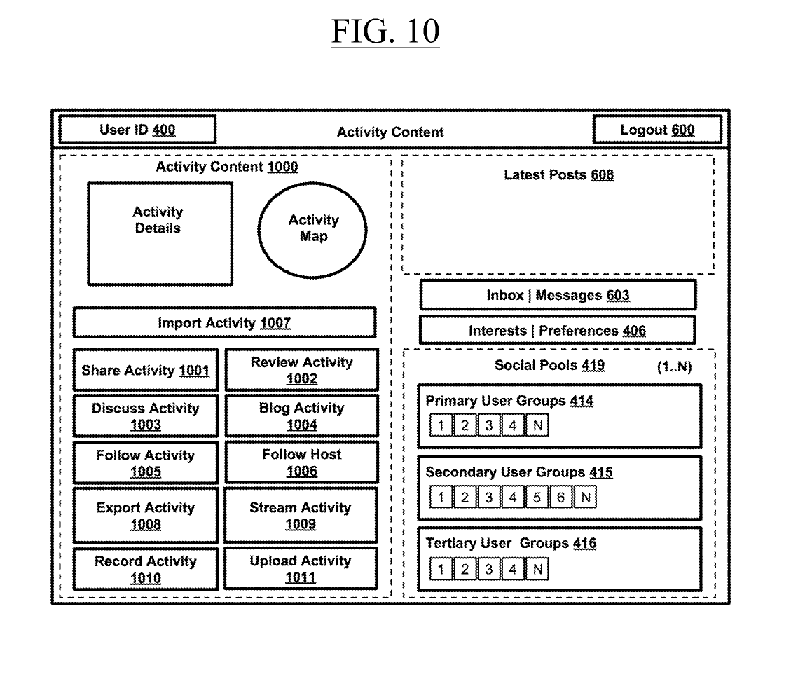

FIG. 10 illustrates an example activity content page in a content module, as may be viewed on a client like a Web browser on a non-mobile or mobile computing device, according to the embodiments as disclosed herein. Activity content 1000 illustrates how a user may interact with other users or the ESP 101 after selecting an activity from a source comprising a personal schedule, GSF 601, USF 401, GMF 617, UMF 417, GAF 607, UAF 407, GCF 618, UCF 418, a search result or an activity discovered while sharing or browsing the ESP 101. A user may attend an activity in person and may interact through the ESP 101 with actions comprising sharing an activity 1001 with other users, reviewing an activity 1002, discussing 1003 or blogging 1004 about an activity with others live, following an activity 1005 or activity provider 1006 for future news and schedules, importing an activity 1007 to a personal schedule 420 or exporting an activity 1008 to a scheduling system on an off-platform device. A user may also use software tools on the ESP 101 to stream an activity 1009, record an activity 1010 or upload files, photos or videos 1011 to a gallery.

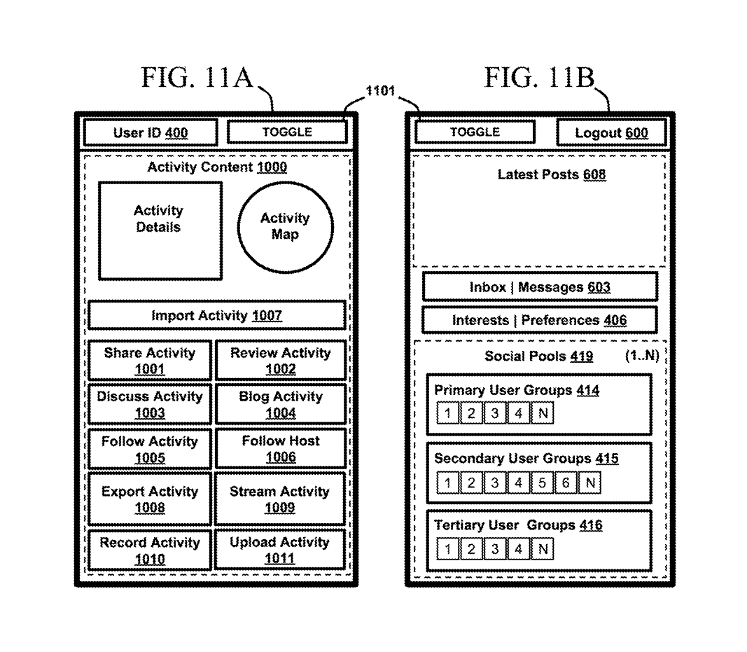

FIG. 11A and FIG. 11B illustrate an example activity content page in a content module, as may be rendered for viewing on a non-mobile or mobile computing device, with a toggle, according to the embodiments as disclosed herein. A toggle 1101 may be used to toggle between activity content 1000 in FIG. 11A among other options, and related activity posts 608 in FIG. 11B. A mobile view may reflect a consolidated version of a non-mobile view as in FIG. 10 with identical functionalities.

### Activity Provider Embodiments

FIG. 12 displays an example activity provider access page in an activity management module, as may be viewed on a client like a Web browser on a non-mobile or mobile computing device, according to the embodiments disclosed herein. For the purpose of illustrating an example implementation, the activity provider embodiments comprise an example wedding with a fragrance garden theme, hosted by SOS Fragrance Store, along with other store activities. A user, as activity provider, may access an activity management console, in this case SOS Fragrance Store, with an ordered list of their activities in queue 1201. FIG. 19 illustrates a flowchart of management options a user, as an activity provider, may face when accessing the platform. Using information from a user or activity provider registration and an activity management module, the ESP 101 may access information for an activity provider and assign an activity ID during an add activity process 1202 as illustrated in FIG. 22. An activity provider (host, vendor, individual, group, corporation, etc.) may then modify 1204 or delete 1203 activity information. Apart from providing basic information, like activity name, dates, times, location, duration, and categories, a user may compile invitation lists 1205, friend lists 1208, associates lists 1209 or groups lists 1210. An activity provider may also share activity specific information and activity data objects, such as a point of contact person, details of a business, such as service offerings, marketing materials, brand collateral, pricing or product lists, menus, itineraries, agendas, video, direction maps and so on, from a media bin 1206. Activity data objects may be uploaded and maintained on an individual activity basis, because items are indexed, and stored in a database with a media ID and may be linked to an activity ID and said activity data objects shared via email, voice messaging, SMS messaging, in-box messaging 1207 or shared on other social media platforms via a widget plug-in. In a notification area 1207, documents are indexed with a notification ID and an activity provider may select from a collection of pre-made or canned emails, messages, notices, upload their own templates for use in initial email blasts or compose an entirely new one. When sending notices, activity providers may make friends 1208, groups 1210 or associates 1209 administrative assignments, block users from an invite list 1205 and choose to publicize or make private invite lists. As a part of a group assignment process, an activity provider may assign permissions to groups or individuals, such as an ability to edit event times, upload media, send notices, delete activities, etc. This may be helpful, in our wedding example, when an extended family member is given the authority to change the time of the reception. A user may utilize an indexing capability of linking an activity ID and a location ID, which are assigned during an add activity process shown in FIG. 22 to make this happen. This may be useful in instances where multiple locations of an activity are occurring. Additionally, through an activity management module, a user may consolidate groups of activities as part of a larger activity or task by assigning a parent ID to an event and assign sub-activities within an umbrella of a parent activity using a link activity tab 1211. For example, if SOS Fragrance Store has more than one wedding occurring in different cities, a administrative coordinator may be set up as with editing permissions and each wedding comprising subordinate entities that may be assigned to umbrella activities, linked as a group. This may also help in instances where activities are dependent on other activities (i.e., sub-tasks or sub-activities), or for tracking milestones in a project. In our wedding example, the conclusion of the photography session may trigger the reception activity. Under an enhanced model (see Alternative Embodiments below) of participation in the ESP 101, activity providers may have a capability to present customized Web page content for each branch, franchise, outlet and show content, pages, permissions, letter templates specific to their respective business. The ESP 101 has a Web server engine and content management system that allows Web page content to be adapted to specific needs of a business location.

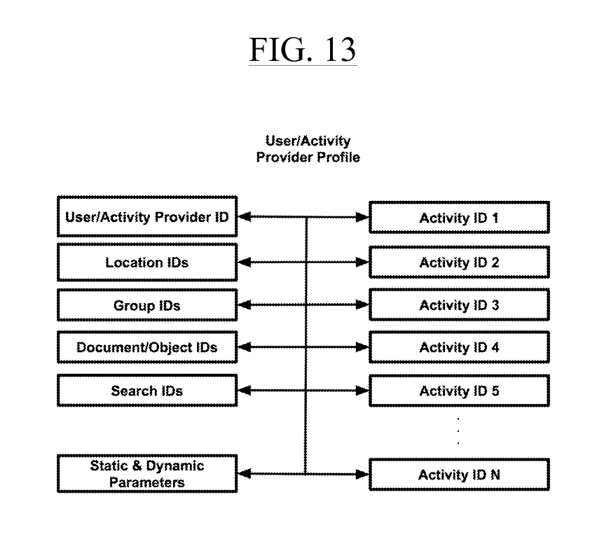

FIG. 13 shows a relationship of a user or activity provider ID as a primary index tying all other data records together, according to the embodiments as disclosed herein. An activity provider ID may tie all objects together across databases with other primary key IDs and subordinating indices as illustrated in FIG. 23. A user or activity provider ID is creating during account creation 503. Using a dynamic GPS locator or mobile location services, or user entered location by address and/or zip code, or geo-positioning data on-the-fly, a user may have multiple location IDs, identifying location profiles 413 to customize data feeds, content flow and narrow interaction to a specific area so that only relative customized user activity information is presented. This may be useful when visiting another city, or planning a visit ahead of time. In our wedding example, out of town visitors may log into their account on the ESP 101 and locate activities to attend after the wedding. In a user or activity provider profile page FIG. 4, a user may save current locations or create new location parameters 413.

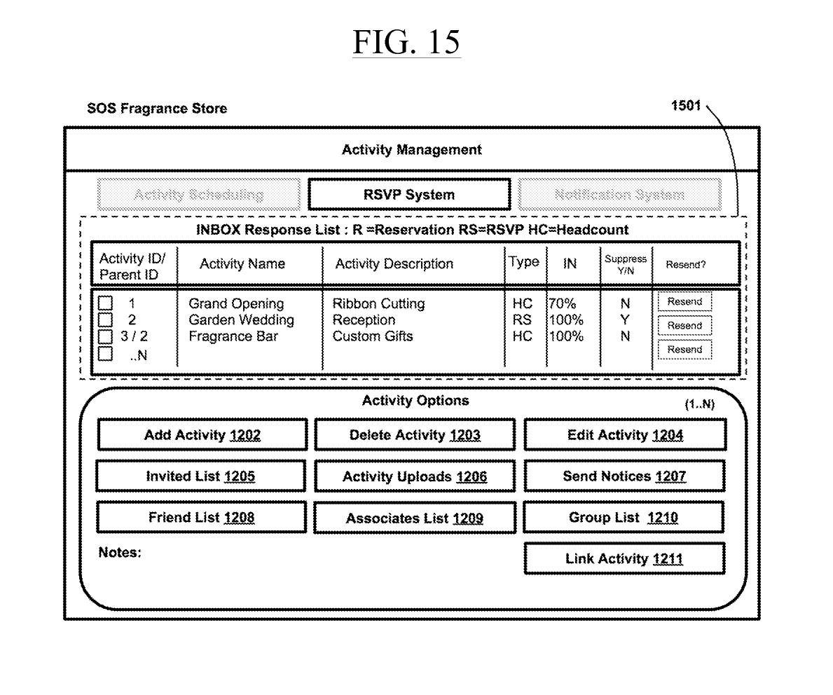

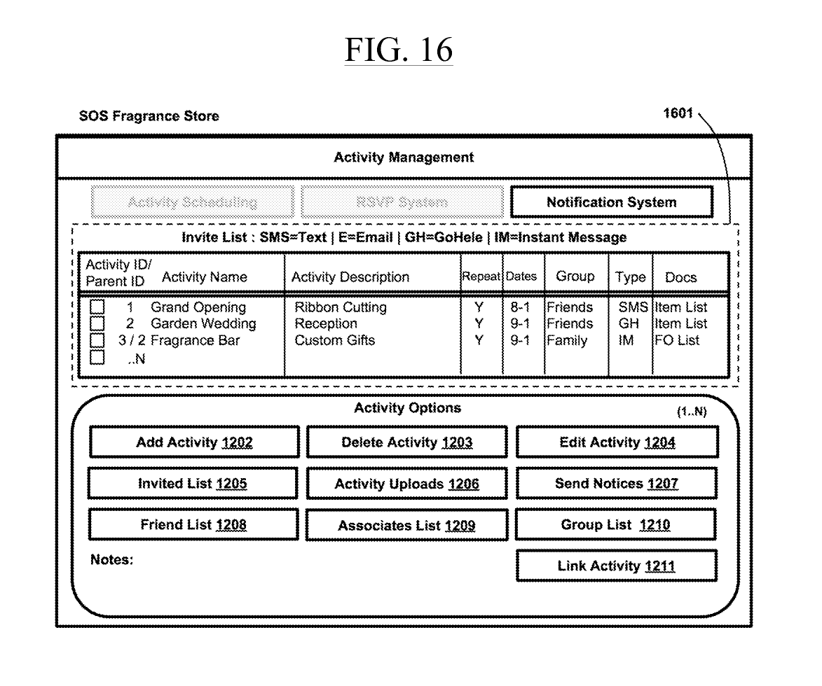

Using information from inputs of a user or activity provider in FIG. 12, FIG. 15, FIG. 16, the ESP 101 may build activity profiles as shown comprising an activity set 1201 that may be linked together because of a commonality or an interrelationship, to affect one another or occur simultaneously. An activity provider may have N activities listed, each with an activity ID. This may be useful when a project or activity requires a multitude of sub-tasks to happen before for an overall project or activity is considered completed, in our example wedding, coordinating of a band, minister, caterer, invitations, photography, fragrance bar, gifts and flowers may all need individual tasks and even sub-tasks within them, to make sure the wedding is a success with some activities relying on other activities being completed before commencing and others occurring simultaneously. All information relating to an activity, including sub-activities may be associated with a corresponding parent activity ID. Some details may be static such as address, contact information, etc., and some may be dynamic, such as duration or attendance levels. Sub-activities are linked to activity IDs to comprise activity sets. All activities hosted by an activity provider may be associated with a single user or activity provider ID, thus each activity may have a unique activity ID associated with a user ID. All parameters being tracked and indexed for an activity provider may be related to a corresponding activity. Therefore, each parameter may be linked to a unique user ID, through a relationship between an activity ID and a user or activity provider ID. A relationship may allow a search parameter, or group of parameters, to be linked to a search profile for each user 413. Search IDs may be attached to a user or activity provider ID and therefore search IDs may be linked to activity IDs. Also shown is a relationship between media, documents and files to a user ID. A user or activity provider may attach files, media, documents to an account profile, such as menus, marketing documents, business files, or agendas 409, stream live video 411 from a personal profile page or from an activity management module 1206, and assign document IDs or object IDs. Document IDs or object IDs may be directly attached to user IDs and may be linked to activity IDs, and depending on a nature of a file, document or object, a user or activity provider may then define access permissions on a per item basis. Relating to this ability is an assignment of group IDs during an affiliation set up process. A user or activity provider may define a social pool comprising a friend and associates pools module 419 further comprising primary (i.e., close or familial) friends and groups list (PUG) 414, secondary (i.e., casual or extended) friends and groups list (SUG) 415 and tertiary (i.e., professional) associates and groups list (TUG) 416; and by doing so assign them group IDs with varying administrative access permissions to portions of a user or activity provider accounts, friend admin security 1208, group admin security 1210 and associates admin security 1209. Similar to other IDs, a group ID may be associated with an activity ID through a relationship with a user or activity provider ID. In our wedding example, a user or activity provider may grant extended friends a “viewing only” access to view an seating chart, rather than update or sharing permissions.

FIG. 13 illustrates an activity notification flow between a user domain and an activity provider domain according to the embodiments disclosed herein. Through the ESP 101, both domains are essentially the same in that data may be collected and stored in a user or activity provider database 201, content database 202 and activity database 203. Communication may pass through the ESP 101 for routing, tracking and archiving, and it is through the platform that alerting and mailing is most effective. An activity provider may send mass alerts, SMS messages and mass mailings to the public, individual groups, or associates, etc., suppress notification on a user-by-user basis; track RSVPs, headcounts, and reservation counts for each event. A user or activity provider may also receive responses accordingly and view them in an organized environment on a per activity basis. A user (as activity provider) may also pre-schedule or send out reminder notices anytime in advance, or if needed at a moments notice, when last minute changes are made and require immediate dispatch. Also, with the ESP 101 interface, an activity provider may attach information data objects from a media bin to a mailing. For our wedding example, it may be a useful follow up tool for thank you notices from the family or event surveys and feedback for future SOS Fragrance Store improvements.

FIG. 15 depicts an example RSVP page in an activity management module, according to the embodiments disclosed herein. A user, as activity provider, may access an RSVP module, in this case SOS Fragrance Store, with an ordered list of their activities in queue 1501. Displayed in the main content area is an inbox or response list 1501 pertaining to individual activities and notification options relating to each. Once an activity has been set up, a user may attach notification options to it for an initial mailing. For each activity, an activity provider may decide if there are criteria that need to be met in order to attend or join an event. For example, for our wedding, the activity provider may require an RSVP in order to attend or join an event, due to capacity restrictions. An activity provider may simply require a headcount, so a “yes” or “no” type response may be needed to know how many individuals for whom a food caterer must prepare. Some tables closer to the married couple may require RSVPs. After deciding a response type, an activity provider may send or resend invites, instructions, agendas, and other pertinent activity specific information data objects, i.e. directions, instructions, maps, gift registry lists, and so on, from their media bin 1206 via email, voice or SMS text or instant message 1207. If desired, in a notification area 1207, an activity provider may select from a collection of pre-made, canned response requested emails, messages, notices, upload their own templates for use in initial email blasts or compose an entirely new one. An RSVP page may track counts per type of notification received and activity providers may quickly decide to suppress or resend notifications, i.e., for event rescheduling or if at a full capacity status. Also here, is an ability to add 1202, delete 1203, or modify 1204 activities for convenience. An activity provider may create custom lists or access their mailing lists on a per activity basis for a recipient list. For example, by ticking a select box for an activity in an activity list 1501 and then clicking a send notices 1207 tab section along with an associate's list 1209, an activity provider may send or resend a particular invite type to that group. An activity provider may similarly access a list of groups, manage guests, send notices and make invite lists public or private.

FIG. 16 illustrates an example notification system in an activity management module, according to the embodiments as disclosed herein. A notification system is similar to an RSVP system, in that a queue of activities and related notification attributes 1601 may occupy a main content area. However, notification options may relate to non-RSVP mailings, such as a frequency, duration, and timing of activities. An activity provider may send out non-RSVP ad-hoc notices and status updates comprising canned emails and messages 1207 for ease of sending mass mailings across the network. An activity provider may create custom lists or access mailing lists on a per activity basis for a recipient list. For example, by ticking a select box for an activity in an activity list 1601 and then clicking a send notice 1207 tab along with an associates list 1209, an activity provider may send or resend a particular email or message to a group or compose a new message. An activity provider may similarly access a list of groups, manage guests, send notices and make invitation lists public or private.

To summarize, unique features that make this platform differ from other systems may be an up-to-the-minute, real-time access to activities that would otherwise be unknown through a GSF 601 and a USF 401. Also key, may be an ability to import 407 activities from a GSF 601 and a USF 401 into a user's personal schedule 420 as a tool for immediate planning Because it is activity centered, the platform may allow sharing of actual activities, highlighting the dynamic nature of experiencing moments first hand and sharing moments with others as they happen, with live video streaming, live one on one, one to many chatting 411 or with live discussion 608. Other systems allow for schedule and calendar sharing or a sharing of information data objects and snapshots of life, but this platform may dynamically share an activity as it unfolds. A scrolling chat box 608 on a per identity basis (based on user stored or on-the-fly defined parameters) may dynamically show what others with similar interest are talking about at that moment, alongside activities happening at that moment. This platform may offer a key ability to create various identities and save various profiles, based on interest stacks, activity sets 404, customized search options or favorite locations 413, so that the most relevant data may be served to a user regardless of location or time of day. The platform also may put the power of instantly mobilizing people in the hands of a user unlike ever before. Streaming activities live 411 and archiving activity collections of uploaded files, data, video, posts, images and conversations 409, may powerfully memorialize activities for associates, a family or group. Finally, marketing aspects of the platform across many industries may offer concrete monetizing possibilities that in many ways be more solid than other social media platforms.

### Alternative Embodiments

The invention as described above has within its design, intent and scope, scalability and flexibility for deployment online or offline. The invention with the embodiments herein, is targeted towards everyone. However, just as depicted activity management modules FIG. 12, FIG. 15, FIG. 16, may do for activities, simply adding additional modules, utilizing or not using database records, document templates and specialized data entry interfaces, the ESP 101 and SMS 213 may be tailored to specific businesses on any LAN/WAN. Any enterprise that requires organizing and mobilizing groups around a time sensitive deadline to achieve a desired result or project deliverable, i.e., event planning, travel business, party planners, and contractors, may realize value in the invention. With the embodiments herein, the ESP 101 is a foundation that within its composition has an ability to define, assign and track “activity units” or “activity entities” automatically and generate reminders and status updates at critical dates, thus guaranteeing completion—for example, a scheduling and completing of individual tasks to make a store liquidation sale a success or pull off a wedding without a hitch. Sub-tasks would in themselves be “child” activities that may be monitored and tracked via activity ID's and assigned parent ID's. A workflow set up this way may minimize paper and shorten activity durations—aiding businesses large and small in areas such as agenda coordination, meeting scheduling, training classes, project planning, convention organizing and so forth. Corporate businesses may use the platform to formulate project plans, assign deliverable dates and steps within, to complete a project, all while being able to upload files, forms, videos, live streams, presentations for others in a group to view, and collaborate online while preserving a history of meeting minutes. Travel businesses may use the platform to plan itineraries for visitor tours and vacations.

Possible embodiments of the invention may be as outlined here: 1) as an activity coordinator, the invention functions like an event announcer of a three-ring circus, but with unlimited rings all over the world, in every city. As an announcer, the ESP 101 may keep users abreast through its automatic scheduling feeds GSF 601 and USF 401, of activities happening continuously in their area, so that at any moment a decision could be made whether to attend or join an activity, alone or with friends, online or offline, and interact with other users while there if desired 608. To add to the dynamic nature, a user may pop on over to another locale, neighborhood or country and find out what is happening there in a snap. 2) The invention may operate as a day planner or organizer. Through its user settings 402, search profiles 413, location profiles 413, identities may be stored for retrieval later and used to access activity data and present user specific activity information. Notifications 1207 may be set to remind a user of upcoming activities so that a day may be planned to the minute, making the most of every day. 3) The invention may also function as a diary-like repository 409 archiving shared activities online indefinitely, so a graduation party or birth of a baby, for example, may be shared in real-time or as a recorded activity, with documents, files, discussions, etc. archived forever. 4) The invention may also be an all-in-one marketing tool. The platform may allow anyone to post an activity regardless of their size or budget reach and exposure is the same for large or small entities and individuals alike. A media storage 1206, on a per activity provider profile level may allow for a promotion of a business image, through menus, product lists, press items, sample portfolios, etc. and media storage on a per activity basis may build powerful brand recognition. By making activity announcements worldwide, business may increase their attendance. Higher foot traffic means more eyeballs, more exposure, more sales and more fun. 5) The platform may be a motivator by showing a user what they could be missing in a format that is simple and relatable, exciting people to act, encouraging users to get out and enjoy life wherever they are, and engaging users in dynamic real-time interaction both online and offline.

The embodiments disclosed herein can be implemented through at least one software program running on at least one hardware device and performing network management functions to control the network elements. The network elements shown in FIG. 3 may be at least one of a hardware device, or a combination of hardware device and software modules. It is understood that in the art that any of the aforementioned usage of interfaces, widgets and form controls may be enacted by various other similar programming means and on other operating platforms and devices.

In accordance with the provisions of the patent statutes, the principle and mode of operation of this invention have been explained and illustrated in its preferred embodiment. Although an embodiment has been described with reference to specific example embodiments, it will be evident that various modifications and changes may be made to these embodiments without departing from the broader spirit and scope of the invention. The examples used in the description of this invention are intended to facilitate an understanding of ways in which the embodiments herein function. Accordingly, the specification and drawings are to be regarded in an illustrative rather than a restrictive sense, to inform and help visualize the processes. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be used and derived there from, such that structural and logical substitutions and changes may be made without departing from the scope of this disclosure. Furthermore, it is to be understood that the phraseology or terminology employed herein is for the purpose of description and not of limitation. This detailed description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim. Moreover, in the following claims, ordinal lists if used, are used merely as labels and are not intended to impose numerical requirements on their objects.

The abstract of the disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing detailed description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the detailed description, with each claim standing on its own as a separate embodiment.

CITED REFERENCES

| | | Publication | | |
|---|---|---|---|---|
| Cited Patent | Filing Date | Date | Applicant | Title |
| U.S. Pat. No. 7,441,198 | 16-Dec-05 | 21-Oct-08 | Accenture Global | Virtual collaboration |
| | | | Services Gmbh | window system and method |
| U.S. Pat. No. 7,848,765 | 27-May-05 | 7-Dec-10 | Where, Inc. | Location-based services |
| U.S. Pat. No. 8,060,827 | 30-Nov-06 | 15-Nov-11 | Red Hat, Inc. | Method and system for |
| | | | | preloading suggested content |
| | | | | onto digital video recorder |
| | | | | based on social |
| | | | | recommendations |
| U.S. Pat. No. 8,091,032 | 30-Nov-06 | 3-Jan-12 | Red Hat, Inc. | Automatic generation of |
| | | | | content recommendations |
| | | | | weighted by social network |
| | | | | context |
| U.S. Pat. No. 8,176,191 | 30-Nov-06 | 8-May-12 | Red Hat, Inc. | Automated identification of |
| | | | | high/low value content based |
| | | | | on social feedback |
| U.S. Pat. No. 8,185,584 | 31-May-06 | 22-May-12 | Red Hat, Inc. | Activity history management |
| | | | | for open overlay for social |
| | | | | networks and online services |
| U.S. Pat. No. 8,438,310 | 1-Oct-08 | 7-May-13 | Adp Dealer | Systems and methods for |
| | | | Services, Inc. | configuring a Web site |
| | | | | having a plurality of |
| | | | | operational modes |
| U.S. Pat. No. 8,463,295 | 7-Dec-11 | 11-Jun-13 | Ebay Inc. | Systems and methods for |
| | | | | generating location-based |
| | | | | group recommendations |
| U.S. Pat. No. 8,463,893 | 30-Nov-06 | 11-Jun-13 | Red Hat, Inc. | Automatic playlist |
| | | | | generation in correlation |
| | | | | with local events |
| U.S. Pat. No. 8,478,306 | 10-Nov-10 | 2-Jul-13 | Google Inc. | Self-aware profile switching |
| | | | | on a mobile computing |
| | | | | device |
| U.S. Pat. No. 8,595,322 | 21-Oct-11 | 26-Nov-13 | Microsoft | Target subscription for a |
| | | | Corporation | notification distribution |
| | | | | system |
| U.S. Pat. No. 8,627,411 | 17-Jun-10 | 7-Jan-14 | Microsoft | Techniques to share binary |
| | | | Corporation | content |
| U.S. Pat. No. 8,694,462 | 21-Oct-11 | 8-Apr-14 | Microsoft | Scale-out system to acquire |
| | | | Corporation | event data |
| U.S. Pat. No. 8,712,841 | 16-Nov-10 | 29-Apr-14 | Cellco | Incentive based |
| | | | Partnership | recommendation method for |
| | | | | mobile station content |
| U.S. Pat. No. 8,718,551 | 11-Oct-11 | 6-May-14 | Blackbird | Method and apparatus for a |
| | | | Technology | multi-band, multi-mode |
| | | | Holdings, Inc. | smartcard |
| US20020055992 | 2-Nov-01 | 9-May-02 | John King | Method of providing a |
| | | | | screen saver on a cellular |
| | | | | telephone |
| US20020067308 | 6-Dec-00 | 6-Jun-02 | Xerox | Location/time-based |
| | | | Corporation | reminder for personal |
| | | | | electronic devices |
| US20020086680 | 15-Nov-01 | 4-Jul-02 | Hunzinger Jason F. | Location specific reminders |
| | | | | for wireless mobiles |
| US20020120351 | 18-Dec-01 | 29-Aug-02 | Urpo Tuomela | Context-based data logging |
| | | | | and monitoring arrangement |
| | | | | and a context-based |
| | | | | reminder |
| US20030014274 | 7-Jun-02 | 16-Jan-03 | Denis Chalon | Method of maintaining a |
| | | | | user profile |
| US20030038892 | 29-Mar-02 | 27-Feb-03 | Sidney Wang | Enhancing broadcast of an |
| | | | | event with synthetic scene |
| | | | | using a depth map |
| US20030097457 | 8-Aug-02 | 22-May-03 | Amitabh Saran | Scalable multiprocessor |
| | | | | architecture for business |
| | | | | computer platforms |
| US20030158931 | 5-Feb-03 | 21-Aug-03 | Yasuhiko | Information equipment |
| | | | Nishimuta | management system |
| US20040015551 | 11-Apr-03 | 22-Jan-04 | Barry Thornton | System of co-located |
| | | | | computers with content |
| | | | | and/or communications |
| | | | | distribution |
| US20040192311 | 11-Mar-03 | 30-Sep-04 | Nokia | A method and a system for |
| | | | Corporation | presenting reminders in a |
| | | | | portable device |
| US20040230685 | 23-Jan-03 | 18-Nov-04 | Seligmann Doree | Location-based to-do list |
| | | | Duncan | reminders |
| US20050015482 | 24-May-03 | 20-Jan-05 | Mark | Attachment manager for |
| | | | Blankenship | tracking customer attributes |
| US20050108377 | 31-Dec-03 | 19-May-05 | Soo-hyung Lee | Method for detecting |
| | | | | abnormal traffic at network |
| | | | | level using statistical |
| | | | | analysis |
| US20050283308 | 16-Jun-05 | 22-Dec-05 | Alcatel | Method for providing a |
| | | | | location-based appointment |
| | | | | service |
| US20060015923 | 3-Sep-02 | 19-Jan-06 | Mei Chuah | Collaborative interactive |
| | | | | services synchronized with |
| | | | | real events |
| US20060031317 | 4-Jun-04 | 9-Feb-06 | Wanrong Lin | System for synthesizing |
| | | | | instant message and presence |
| | | | | attributes from polled, |
| | | | | queried and event |
| | | | | information sources |
| US20060036463 | 19-May-05 | 16-Feb-06 | Paul Patrick | Liquid computing |
| US20060155847 | 10-Jan-05 | 13-Jul-06 | William Brown | Deriving scenarios for |
| | | | | workflow decision |
| | | | | management |
| US20060195361 | 12-May-06 | 31-Aug-06 | Outland Research | Location-based demographic |
| | | | | profiling system and method |
| | | | | of use |
| US20060225076 | 14-Mar-06 | 5-Oct-06 | Roberto | Location-aware personal |
| | | | Longobardi | scheduler |
| US20060253481 | 21-Jun-06 | 9-Nov-06 | Guido Matthew A | Geographic database |
| | | | | organization that facilitates |
| | | | | location-based advertising |
| US20070024527 | 29-Jul-05 | 1-Feb-07 | Nokia | Method and device for |
| | | | Corporation | augmented reality message |
| | | | | hiding and revealing |
| US20070073810 | 1-Aug-06 | 29-Mar-07 | Research In | Scheduling events from |
| | | | Motion Limited | electronic messages |
| US20070136417 | 14-Dec-05 | 14-Jun-07 | Barrett Kreiner, | Guest browser |
| | | | Amy Zwarico | |
| US20070168549 | 19-Jul-06 | 19-Jul-07 | Ouelid | Enhanced digitial video |
| | | | Abdesselem | broadcast idle mode in |
| | | | | wireless communication |
| | | | | networks |
| US20070174844 | 21-Dec-05 | 26-Jul-07 | Gregory Adams | System and algorithm for |
| | | | | monitoring event |
| | | | | specification and event |
| | | | | subscription models |
| US20070179792 | 30-Jan-06 | 2-Aug-07 | Kramer James F | System for providing a |
| | | | | service to venues where |
| | | | | people aggregate |
| US20070180149 | 31-Aug-06 | 2-Aug-07 | Michael S. | Varying of message |
| | | | Vernal | encoding |
| US20070217585 | 16-Mar-06 | 20-Sep-07 | Sbc Knowledge | Method and apparatus for |
| | | | Ventures Lp | event notification |
| US20070233852 | 31-Mar-06 | 4-Oct-07 | Jack Jachner | Presence logging in calendar |
| | | | | systems |
| US20070255831 | 28-Apr-06 | 1-Nov-07 | Yahoo! Inc. | Contextual mobile local |
| | | | | search based on social |
| | | | | network vitality information |
| US20070260724 | 17-Apr-07 | 8-Nov-07 | Sandy Rowley | Networking architecture |
| US20070299977 | 22-Jun-06 | 27-Dec-07 | Arieh Markel | Use of URI-specifications in |
| | | | | meta-data driven |
| | | | | instrumentation |
| US20080034047 | 7-Aug-06 | 7-Feb-08 | Rosenberg | Calendar event, notification |
| | | | Gregory A | and alert bar embedded |
| | | | | within mail |
| US20080079566 | 28-Sep-06 | 3-Apr-08 | Singh Munindar P | Apparatus And Method For |
| | | | | Providing A Task Reminder |
| | | | | Based On Travel History |
| US20080082651 | 28-Sep-06 | 3-Apr-08 | Singh Munindar P | System And Method For |
| | | | | Providing A Task Reminder |
| US20080086455 | 29-Dec-06 | 10-Apr-08 | Aol Llc | Communicating appointment |
| | | | | and/or mapping information |
| | | | | among a calendar application |
| | | | | and a navigation application |
| US20080114638 | 10-Nov-06 | 15-May-08 | Inspection | Parameter-based |
| | | | Management | appointment scheduling |
| | | | Systems, Inc. | system and method |
| US20080126476 | 4-Aug-05 | 29-May-08 | Nicholas Frank C | Method and System for the |
| | | | | Creating, Managing, and |
| | | | | Delivery of Enhanced Feed |
| | | | | Formatted Content |
| US20080177858 | 19-Jan-07 | 24-Jul-08 | Ari Aarnio | Arranging dynamic |
| | | | | bookmarks based on service |
| | | | | provider inputs |
| US20080235084 | 20-Mar-07 | 25-Sep-08 | Yahoo! Inc. | Employing matching of |
| | | | | event characteristics to |
| | | | | suggest another |
| | | | | characteristic of an event |
| US20080281904 | 11-May-07 | 13-Nov-08 | Christopher L. | Associating service listings |
| | | | Conrad | with open source projects |
| US20080320139 | 25-Jun-07 | 25-Dec-08 | Matthew K. | Social mobilized content |
| | | | Fukuda | sharing |
| US20090036148 | 1-Aug-07 | 5-Feb-09 | Research In | Mapping an event location |
| | | | Motion Limited | via a calendar application |
| US20090148124 | 11-Feb-09 | 11-Jun-09 | Yahoo!, Inc. | Distributed Automatic |
| | | | | Recording of Live Event |
| US20090158189 | 18-Dec-07 | 18-Jun-09 | Ibrahim M. Itani | Predictive monitoring |
| | | | | dashboard |
| US20090197619 | 26-Nov-08 | 6-Aug-09 | Palm, Inc. | System and method for |
| | | | | providing advertisement data |
| | | | | to a mobile computing |
| | | | | device |
| US20090291677 | 23-May-08 | 26-Nov-09 | Microsoft | Media Content for a Mobile |
| | | | Corporation | Media Device |
| US20100076828 | 23-Sep-08 | 25-Mar-10 | Neufeld Nadav M, | Targeted Advertising using |
| | | | | Object Identification |
| US20100205541 | 11-Feb-09 | 12-Aug-10 | Jeffrey A. | social network driven |
| | | | Rapaport | indexing system for instantly |
| | | | | clustering people with |
| | | | | concurrent focus on same |
| | | | | topic into on-topic chat |
| | | | | rooms and/or for generating |
| | | | | on-topic search results |
| | | | | tailored to user preferences |
| | | | | regarding topic |
| US20100235748 | 14-May-10 | 16-Sep-10 | Johnson William J | System and method for |
| | | | | automated content |
| | | | | presentation objects |
| US20100312646 | 21-Dec-07 | 9-Dec-10 | Yahoo! Inc. | System for serving |
| | | | | advertisements targeted to |
| | | | | geographic areas over |
| | | | | mobile devices |
| US20110040627 | 11-Aug-09 | 17-Feb-11 | Microsoft | Viral advertisements |
| | | | Corporation | |
| US20110055894 | 31-Aug-09 | 3-Mar-11 | Shen-Chang | Firewall and NAT Traversal |
| | | | Chao | for Social Networking and/or |
| | | | | Content Sharing On Mobile |
| | | | | Devices |
| US20110061108 | 9-Sep-09 | 10-Mar-11 | Nokia | Method and apparatus for |
| | | | Corporation | media relaying and mixing in |
| | | | | social networks |
| US20110066743 | 14-Sep-09 | 17-Mar-11 | Fergus Gerard | Method for providing event |
| | | | Hurley | based media streams |
| US20110161167 | 30-Dec-10 | 30-Jun-11 | Srikanth | Social media platform for |
| A1 | | | Jallapuram | providing interactive |
| | | | | services |
| US20110218845 | 5-Mar-10 | 8-Sep-11 | Maria Medina | Interactive Advertising for |
| | | | | Computer Mediated |
| | | | | Communications |
| US20110288912 | 12-May-11 | 24-Nov-11 | Comcast Cable | Content Recommendation |
| | | | Communications, | System |
| | | | Llc | |
| US20110301941 | 18-Mar-10 | 8-Dec-11 | Syl Research | Natural language processing |
| | | | Limited | method and system |
| US20120004956 | 14-Jul-11 | 5-Jan-12 | Huston Charles D | System and Method for |
| | | | | Creating and Sharing an |
| | | | | Event Using a Social |
| | | | | Network |
| US20120021778 | 30-Sep-11 | 26-Jan-12 | Google Inc. | Determining a geographical |
| | | | | location |
| US20120054808 | 26-Aug-10 | 1-Mar-12 | Cox | Playlist Bookmarking |
| | | | Communications, | |
| | | | Inc. | |
| US20120078713 | 23-Sep-10 | 29-Mar-12 | Sony Corporation | System and method for |
| | | | | effectively providing |
| | | | | targeted information to a |
| | | | | user community |
| US20120115501 | 10-Nov-10 | 10-May-12 | Google Inc. | Self-aware profile switching |
| | | | | on a mobile computing |
| | | | | device |
| US20120117024 | 1-Nov-11 | 10-May-12 | Samsung | Method for updating media |
| | | | Electronics Co. | database in portable terminal |
| | | | Ltd. | |
| US20120136572 | 16-Jun-11 | 31-May-12 | Norton Kenneth S | Distance and Location- |
| | | | | Aware Reminders in a |
| | | | | Calendar System |
| US20120179981 | 5-Jan-12 | 12-Jul-12 | Meetup, Inc. | Collaboration Meeting |
| | | | | Management in a Web- |
| | | | | Based Interactive Meeting |
| | | | | Facility |
| US20120233546 | 9-May-11 | 13-Sep-12 | 3CLogic | System and method for |
| | | | | providing voice, chat, and |
| | | | | short message service |
| | | | | applications usable in social |
| | | | | media to service personal |
| | | | | orders and requests by at |
| | | | | least one agent |
| US20120278381 | 29-Apr-11 | 1-Nov-12 | Andrew Rodney | Integrating an Online |
| | | | Ferlitsch | Meeting with an Offline |
| | | | | Calendar |
| US20130012240 | 28-Feb-12 | 10-Jan-13 | Samsung | Method and apparatus for |
| | | | Electronics Co. | obtaining information of user |
| | | | Ltd. | equipment in communication |
| | | | | system |
| US20130046619 | 7-Aug-12 | 21-Feb-13 | Daniel Alberto | System and method for |
| | | | TRANSLATEUR | targeted advertising |
| US20130066908 | 4-Jul-11 | 14-Mar-13 | Research In | System and method for |
| | | | Motion Limited | sharing mobile device |
| | | | | content |
| US20130091053 | 2-Nov-11 | 11-Apr-13 | Hanhwa Solution | Apparatus for providing |
| | | | & Consulting | service linking closed user |
| | | | Co., Ltd | groups based on smart |
| | | | | television and smart set-top |
| | | | | box |
| US20130111516 | 13-Sep-12 | 2-May-13 | Kt Corporation | Apparatus and method for |
| | | | | providing a customized |
| | | | | interface |
| US20130129232 | 21-Nov-11 | 23-May-13 | Ronald Steven | Group method for making |
| | | | Cok | event-related media |
| | | | | collection |
| US20130297688 | 3-May-12 | 7-Nov-13 | Yahoo! Inc. | Mobile-based realtime |
| | | | | location-sensitive social |
| | | | | event engine |
| WO2012100147 | 20-Jan-12 | 26-Jul-12 | Blackbird | Method and apparatus for |
| A1 | | | Technology | discovering people, products, |
| | | | Holdings, Inc. | and/or services via a |
| | | | | localized wireless network |
| WO2013163397 | 25-Apr-13 | 31-Oct-13 | Nike | Social media product |
| A1 | | | International Ltd. | reservation |
| WO2014059023 | 9-Oct-13 | 17-Apr-14 | Cvent, Inc. | Providing activity feed for |
| A1 | | | | events to facilitate gathering |
| | | | | and communicating of event |
| | | | | information |
| EP1569478A1 | 27-Feb-04 | 31-Aug-05 | Research In | Methods and apparatus for |
| | | | Motion Limited | automatically grouping user- |
| | | | | specific information in a |
| | | | | mobile station |
| EP1785892A2 | 1-Nov-05 | 16-May-07 | Research In | System and Method for |
| | | | Motion Limited | Collecting and Presenting |
| | | | | Records in a Journal on an |
| | | | | Electronic Device |
| EP1993270A1 | 12-May-07 | 19-Nov-08 | Nitesh Ratnakar | System and method for |
| | | | | automatically downloading |
| | | | | and storing contact |
| | | | | information to a personal |
| | | | | communication device based |
| | | | | on a geographical position of |
| | | | | the personal communication |
| | | | | device-yellow book for the |
| | | | | phone |
| EP2000961A1 | 1-Jun-07 | 10-Dec-08 | Research In | Proximity-dependent events |
| | | | Motion Limited | |
| EP2509040A1 | 24-Feb-10 | 10-Oct-12 | Research In | System and method for |
| | | | Motion Limited | displaying an advertisement |
| | | | | on a mobile device |

The invention claimed is:

1) A method for enabling integrated connectivity and continued interaction between users through an activity-sharing, social network platform wherein said activity-sharing, social network platform comprises a network-based system of one or more processors and at least one user Web enabled device, said method may comprise:
receiving, at said network-based system of one or more processors, a request by a user, to access said activity-sharing, social network platform and a relational database stored therein;
receiving, using one or more processors within said network-based system, the coordinates of said user's geo-position or range;
retrieving, using one or more processors within said network-based system, from said relational database, said user's account information;
receiving, using one or more processors within said network-based system, a search term or query parameters from said user;
generating, using one or more processors within said network-based system, a predictive recommendation list or dataset of activity database records for said user's review, said predictive recommendation list or dataset generated based on:
querying, using one or more processors within said network-based system, said activity database records stored in said relational database by determining which said activity database records comply with at least one of said user's search term, said user's query parameters, said user's geo-position or range and said user's account information, according to said search term, said query parameters, said user geo-position or range and/or matched said user account information; and
extracting, using one or more processors within said network-based system, matched activity database records based on said query;
wherein the said predictive recommendation list or dataset includes said matched activity database records;
in response to receiving said predictive recommendation list or dataset, determining, using one or more processors within said network-based system, an alert in connection with an activity database record of said predictive recommendation list or dataset and associated with at least one of one processor in said network-based system, said user Web enabled device, said user's selected service option, or said user account information;
forwarding, from one or more processors within said network-based system to said user Web enabled device, said alert;
forwarding, from one or more processors within said network-based system to said user's personal on-platform or off-platform mailboxes or repositories, said alert;
presenting, using one or more processors within said network-based system, service options available that may be linked to said alert or said activity database record; and
executing, using one or more processors within said network-based system, said user selected service option.

2) The method as in claim 1, wherein said request by a user may comprise:
connecting, using a Web enabled device, to said relational database;
connecting, using a Web enabled device, to said activity-sharing, social network platform;
connecting, using a widget(s) or plug-in(s), to said relational database;
connecting, using a widget(s) or plug-in(s), to said activity-sharing, social network platform;
connecting, using third party software, to said relational database; and
connecting, using third party software, to said activity-sharing, social network platform.

3) The method as in claim 1, wherein said user may comprise an individual, consumer, group, closed user group, user-agent, automated agent, corporate or a commercial entity.

4) The method as in claim 2, wherein said widgets may comprise blocks of program code or logic that can be embedded or incorporated into the program code of electronic media comprising social networks, social media, social platforms, software applications, clients, Web pages, blog posts, articles, online documents, advertisements, workflow systems, promotional materials, bulletins and emails, to access said relational database and present user service options, to retrieve activity related data from said relational database, activity database records and information data objects and display data of said activity database records and information data objects on said electronic media.

5) The method as in claim 2, wherein said plug-ins may comprise software clients, enhancement tools, installation code, add-on programming logic and software functionality that retrieve activity related data from said relational database, activity database records and information data objects and display data of said activity database records and information data objects on electronic media comprising social networks, social media, social platforms, software applications, clients, Web pages, blog posts, articles, online documents, advertisements, workflow systems, promotional materials, bulletins and emails, said plug-ins may further comprise SOAP, REST API, RSS, JSON or XML activity data feeds.

6) The method as in claim 1, wherein said alert may comprise messaging, notices and reminders of said activities or user interaction that may further comprise: voice messaging, text messaging, feed systems messaging (SOAP, REST, RSS, XML, JSON), SMS messaging, chat client messaging, email messaging, marketing media, promotional media, bulletins, announcements, status reports, statistical reports, trend reports, behavioral tracking and analytics of said activities.

7) The method as in claim 1, wherein said activity may be an offline or online activity, streaming activity, non-streaming activity, live or recorded activity; which may be one among a performance, concert, alert, broadcast, announcement, commercial activity, sale event, open house, recorded audio, recorded video, fund-raiser, conference, political event, speech, sermon, address, reading, discussion, interview, auction, book-signing, lecture, lesson, natural disaster, emergency, flash mob, accident, prank, sports activity, family gathering, get-together, party, celebration, memorial, assembly, protest, meeting, to-do item, task, contract deadline, reservation or appointment.

8) The method as in claim 1, wherein said query parameters or said user account information may comprise parameters inputted by said user, inputted by other users or collected during said user's interaction with said activity-sharing, social network platform further comprising:
a static parameter; wherein a static parameter may be one among activity type, activity location, activity geo-positioning coordinates, activity type of business, activity category, cost of the activity, newness of the activity, activity access permissions, activity visibility, user location, access permissions, preferred availability times, previous history, browsing history, stored interests, stored profiles, stored preferences, stored query parameters, comments of activity by others, shares of activities by others, tags of activities by others, prior activity success, activity ratings as given by an individual user or group, activity provider ratings as given by an individual user or group, on-page filters, search queries, other user's activity reviews and feedback, shared activity liked content, shared activity uploads and tagged promotional files, attendance histories, activity popularity, published event RSVP attendance and published possible wait times; and
a dynamic parameter; wherein a dynamic parameter may be one among said user's current geo-positioning coordinates, relative positions of each user as part of a closed user group that wants to attend or join the activity as a group, proximity of the said user to the activities surrounding said user, said user's desired search radius, new activities being posted in real-time providing more options, existing user's schedule, modified activity data, traffic conditions that affect a user's arrival at an activity, unpredictable weather patterns that affect the event launch, blocks of activity time changes affecting an itinerary, sudden spike in attendance because of a deadline, floods of last minute reservations that lead to late RSVPs, extensive wait times that conflict with the user's preferred time schedule or the schedule of the group.

9) The method as in claim 8, wherein an activity provider may be a user operating in capacity of a moderator, team leader, host, manager, dispatcher, director, organizer, planner, promoter, coordinator, facilitator, instructor or point of contact for an activity.

10) The method as in claim 8 wherein schedule may be one of an organized collection of time and date sensitive activities, which may comprise a daily, weekly, or monthly calendar, activity calendar, meeting calendar, to-do list, task-tracking chart, travel itinerary, agenda, project-based workflow diagram, reservation wait-list or appointment docket.

11) The method as in claim 1, wherein executing said user selected service option may comprise:
adding or editing, using a widget(s) or plug-in(s), a new activity database record to the database;
uploading or editing, using a widget(s) or plug-in(s), an information data object;
streaming, using a widget(s) or plug-in(s), an information data object;
messaging with other users, using a widget(s) or plug-in(s), about or during an activity database record;
messaging with other users, using a widget(s) or plug-in(s), about or during an information data object;
speaking with other users, using a widget(s) or plug-in(s), about or during an activity database record;
speaking with other users, using a widget(s) or plug-in(s), or during an information data object;
viewing other users, using a widget(s) or plug-in(s), when discussing or during an activity database record;
viewing other users, using a widget(s) or plug-in(s), when discussing or during an information data object;
collaborating with other users, using a widget(s) or plug-in(s), about, on or during an activity database record;
collaborating with other users, using a widget(s) or plug-in(s), about, on or during an information data object;
sharing with other users, using a widget(s) or plug-in(s), about, on or during an activity database record; and
sharing with other users, using a widget(s) or plug-in(s), about, on or during an information data object.

12) The method as in claim 11, wherein said information data objects may be one among activity details, promotional materials, maps, blogs, images, graphics, logos, price lists, catalogs, inventory sheets, site plans, videos, files, bookmarks, live streaming content, text, audio files, calendars, menus and schedules.

13) A network-based, information processing system for enabling integrated connectivity and interaction between users through an activity-sharing, social network platform, said information processing system comprising:
a memory with computer-executable instructions stored therein, said computer-executable instructions comprising:
receiving at said network-based system of one or more processors, a request by a user, to access an activity-sharing, social network platform and a relational database stored therein;
receiving, using one or more processors within said network-based system, the coordinates of said user's geo-position or range;
retrieving, using one or more processors within said network-based system, from said relational database, said user's account information;
receiving, using one or more processors within said network-based system, a search term or query parameters from said user;
generating, using one or more processors within said network-based system, a predictive recommendation list or dataset of activity database records for user review, said predictive recommendation list or dataset generated based on:
querying, using one or more processors within said network-based system, said activity database records stored in said relational database by determining which said activity database records comply with at least one of said user's search term, said user's query parameters, said user's geo-position or range and said user's account information, according to said search term, said query parameters, said user geo-position or range and/or matched said user account information; and
extracting, using one or more processors within said network-based system,
matched activity database records based on said query;
wherein the said predictive recommendation list or dataset includes said matched activity database records;
in response to receiving said predictive recommendation list or dataset, determining, using one or more processors within said network-based system, an alert in connection with an activity database record of said predictive recommendation list or dataset and associated with at least one of one processor in said network-based system, said user Web enabled device, said user's selected service option, or said user account information;
forwarding, from one or more processors within said network-based system to said user Web enabled device, said alert;
forwarding, from one or more processors within said network-based system to said user's personal on-platform or off-platform mailboxes or repositories, said alert;
presenting, using one or more processors within said network-based system, service options available that may be linked to said alert or said activity database record; and
executing, using one or more processors within said network-based system, said users selected service option.

14) The method as in claim 13, wherein said request by a user may comprise:
connecting, using a Web enabled device, to said relational database;
connecting, using a Web enabled device, to said activity-sharing, social network platform;
connecting, using a widget(s) or plug-in(s), to said relational database;
connecting, using a widget(s) or plug-in(s), to said activity-sharing, social network platform;
connecting, using third party software, to said relational database; and
connecting, using third party software, to said activity-sharing, social network platform.

15) The method as in claim 13, wherein said user may comprise an individual, consumer, group, closed user group, user-agent, automated agent, corporate or a commercial entity.

16) The method as in claim 14, wherein said widgets may comprise blocks of program code or logic that can be embedded or incorporated into the program code of electronic media comprising social networks, social media, social platforms, software applications, clients, Web pages, blog posts, articles, online documents, advertisements, workflow systems, promotional materials, bulletins and emails, to access said relational database and present user service options, to retrieve activity related data from said relational database, activity database records and information data objects and display data of said activity database records and information data objects on said electronic media.

17) The method as in claim 14, wherein said plug-ins may comprise software clients, enhancement tools, installation code, add-on programming logic and software functionality that retrieve activity related data from said relational database, activity database records and information data objects and display data of said activity database records and information data objects on electronic media comprising social networks, social media, social platforms, software applications, clients, Web pages, blog posts, articles, online documents, advertisements, workflow systems, promotional materials, bulletins and emails, said plug-ins may further comprise SOAP, REST API, RSS, JSON or XML activity data feeds.

18) The method as in claim 13, wherein said alert may comprise messaging, notices and reminders of said activities or user interaction that may further comprise: voice messaging, text messaging, feed systems messaging (SOAP, REST, RSS, XML, JSON), SMS messaging, chat client messaging, email messaging, marketing media, promotional media, bulletins, announcements, status reports, statistical reports, trend reports, behavioral tracking and analytics of said activities.

19) The method as in claim 13, wherein said activity may be an offline or online activity, streaming activity, non-streaming activity, live or recorded activity; which may be one among a performance, concert, alert, broadcast, announcement, commercial activity, sale event, open house, recorded audio, recorded video, fund-raiser, conference, political event, speech, sermon, address, reading, discussion, interview, auction, book-signing, lecture, lesson, natural disaster, emergency, flash mob, accident, prank, sports activity, family gathering, get-together, party, celebration, memorial, assembly, protest, meeting, to-do item, task, contract deadline, reservation or appointment.

20) The method as in claim 13, wherein said query parameters or said user account information may comprise parameters inputted by said user, inputted by other users or collected during said user's interaction with said activity-sharing, social network platform further comprising:
a static parameter; wherein a static parameter may be one among activity type, activity location, activity geo-positioning coordinates, activity type of business, activity category, cost of the activity, newness of the activity, activity access permissions, activity visibility, user location, access permissions, preferred availability times, previous history, browsing history, stored interests, stored profiles, stored preferences, stored query parameters, comments of activity by others, shares of activities by others, tags of activities by others, prior activity success, activity ratings as given by an individual user or group, activity provider ratings as given by an individual user or group, on-page filters, search queries, other user's activity reviews and feedback, shared activity liked content, shared activity uploads and tagged promotional files, attendance histories, activity popularity, published event RSVP attendance and published possible wait times; and
a dynamic parameter; wherein a dynamic parameter may be one among said user's current geo-positioning coordinates, relative positions of each user as part of a closed user group that wants to attend or join the activity as a group, proximity of the said user to the activities surrounding said user, said user's desired search radius, new activities being posted in real-time providing more options, existing user's schedule, modified activity data, traffic conditions that affect a user's arrival at an activity, unpredictable weather patterns that affect the event launch, blocks of activity time changes affecting an itinerary, sudden spike in attendance because of a deadline, floods of last minute reservations that lead to late RSVPs, extensive wait times that conflict with the user's preferred time schedule or the schedule of the group.

21) The method as in claim 20, wherein an activity provider may be a user operating in capacity of a moderator, team leader, host, manager, dispatcher, director, organizer, planner, promoter, coordinator, facilitator, instructor or point of contact for an activity.

22) The method as in claim 20 wherein schedule may be one of an organized collection of time and date sensitive activities, which may comprise a daily, weekly, or monthly calendar, activity calendar, meeting calendar, to-do list, task-tracking chart, travel itinerary, agenda, project-based workflow diagram, reservation wait-list or appointment docket.

23) The method as in claim 13, wherein executing said user's selected service option may comprise:
adding or editing, using a widget(s) or plug-in(s), a new activity database record to the database;
uploading or editing, using a widget(s) or plug-in(s), an information data object;
streaming, using a widget(s) or plug-in(s), an information data object;
messaging with other users, using a widget(s) or plug-in(s), about or during an activity database record;
messaging with other users, using a widget(s) or plug-in(s), about or during an information data object;
speaking with other users, using a widget(s) or plug-in(s), about or during an activity database record;
speaking with other users, using a widget(s) or plug-in(s), or during an information data object;
viewing other users, using a widget(s) or plug-in(s), when discussing or during an activity database record;
viewing other users, using a widget(s) or plug-in(s), when discussing or during an information data object;
collaborating with other users, using a widget(s) or plug-in(s), about, on or during an activity database record;
collaborating with other users, using a widget(s) or plug-in(s), about, on or during an information data object;
sharing with other users, using a widget(s) or plug-in(s), about, on or during an activity database record; and
sharing with other users, using a widget(s) or plug-in(s), about, on or during an information data object.

24) The method as in claim 23, wherein said information data objects may be one among activity details, promotional materials, maps, blogs, images, graphics, logos, price lists, catalogs, inventory sheets, site plans, videos, files, bookmarks, live streaming content, text, audio files, calendars, menus and schedules.

25) A computer program product comprising a computer-readable storage medium with computer instructions stored therein, said computer instructions causing a computer to execute:
receiving a request by a user, to access an activity-sharing, social network platform and a relational database stored therein;
receiving the coordinates of said user's geo-position or range;
retrieving from said relational database, matched said user's account information;
receiving a search term or query parameters from said user;
generating a predictive recommendation list or dataset of activity database records for user review, said predictive recommendation list or dataset generated based on:
querying said activity database records stored in said relational database by determining which said activity database records comply with at least one of said user's search term, said user's query parameters, said user's geo-position or range and said user's account information, according to said search term, said query parameters, said user geo-position or range and/or matched said user account information; and
extracting matched activity database records based on said query;
wherein the said predictive recommendation list or dataset includes said matched activity database records;
in response to receiving said predictive recommendation list or dataset, determining, using one or more processors within said network-based system, an alert in connection with an activity database record of said predictive recommendation list or dataset and associated with at least one of one processor in said network-based system, said user Web enabled device, said user's selected service option, or said user account information;
forwarding, from one or more processors within said network-based system to said user Web enabled device, said alert;
forwarding, from one or more processors within said network-based system to said user's personal on-platform or off-platform mailboxes or repositories, said alert;
presenting, using one or more processors within said network-based system, service options available that may be linked to said alert or said activity database record;
executing, using one or more processors within said network-based system, said user selected service option;
connecting, a Web enabled device, to said relational database;
connecting, a Web enabled device, to said activity-sharing, social network platform;
connecting, a widget(s) or plug-in(s), to said relational database;
connecting, a widget(s) or plug-in(s), to said activity-sharing, social network platform;
connecting, third party software, to said relational database;
connecting, third party software, to said activity-sharing, social network platform;
adding or editing, a new activity database record to the database;
uploading or editing, an information data object;
streaming, an information data object;
messaging with other users using a widget(s) or plug-in(s), about, on or during an activity database record;
messaging with other users using a widget(s) or plug-in(s), about, on or during an information data object;
speaking with other users using a widget(s) or plug-in(s), about, on or during an activity database record;
speaking with other users using a widget(s) or plug-in(s), about, on or during an information data object;
viewing other users using a widget(s) or plug-in(s), when discussing about, on or during an activity database record;
viewing other users using a widget(s) or plug-in(s), when discussing about, on or during an information data object;
collaborating with other users using a widget(s) or plug-in(s), about, on or during an activity database record;
collaborating with other users using a widget(s) or plug-in(s), about, on or during an information data object;
sharing with other users using a widget(s) or plug-in(s), about, on or during an activity database record; and
sharing with other users using a widget(s) or plug-in(s), about, on or during an information data object.

26) The method as in claim 25, wherein said request by a user may comprise:
connecting, using a Web enabled device, to said relational database;
connecting, using a Web enabled device, to said activity-sharing, social network platform;
connecting, using a widget(s) or plug-in(s), to said relational database;
connecting, using a widget(s) or plug-in(s), to said activity-sharing, social network platform;
connecting, using third party software, to said relational database; and
connecting, using third party software, to said activity-sharing, social network platform.

27) The method as in claim 25, wherein said user may comprise an individual, consumer, group, closed user group, user-agent, automated agent, corporate or a commercial entity.

28) The method as in claim 26, wherein said widgets may comprise blocks of program code or logic that can be embedded or incorporated into the program code of electronic media comprising social networks, social media, social platforms, software applications, clients, Web pages, blog posts, articles, online documents, advertisements, workflow systems, promotional materials, bulletins and emails, to access said relational database and present user service options, to retrieve activity related data from said relational database, activity database records and information data objects and display data of said activity database records and information data objects on said electronic media.

29) The method as in claim 26, wherein said plug-ins may comprise software clients, enhancement tools, installation code, add-on programming logic and software functionality that retrieve activity related data from said relational database, activity database records and information data objects and display data of said activity database records and information data objects on electronic media comprising social networks, social media, social platforms, software applications, clients, Web pages, blog posts, articles, online documents, advertisements, workflow systems, promotional materials, bulletins and emails, said plug-ins may further comprise SOAP, REST API, RSS, JSON or XML activity data feeds.

30) The method as in claim 25, wherein said alert may comprise messaging, notices and reminders of said activities or user interaction that may further comprise: voice messaging, text messaging, feed systems messaging (SOAP, REST, RSS, XML, JSON), SMS messaging, chat client messaging, email messaging, marketing media, promotional media, bulletins, announcements, status reports, statistical reports, trend reports, behavioral tracking and analytics of said activities.

31) The method as in claim 25, wherein said activity may be an offline or online activity, streaming activity, non-streaming activity, live or recorded activity; which may be one among a performance, concert, alert, broadcast, announcement, commercial activity, sale event, open house, recorded audio, recorded video, fund-raiser, conference, political event, speech, sermon, address, reading, discussion, interview, auction, book-signing, lecture, lesson, natural disaster, emergency, flash mob, accident, prank, sports activity, family gathering, get-together, party, celebration, memorial, assembly, protest, meeting, to-do item, task, contract deadline, reservation or appointment.

32) The method as in claim 25, wherein said query parameters or said user account information may comprise parameters inputted by said user, inputted by other users or collected during said user's interaction with said activity-sharing, social network platform further comprising:
a static parameter; wherein a static parameter may be one among activity type, activity location, activity geo-positioning coordinates, activity type of business, activity category, cost of the activity, newness of the activity, activity access permissions, activity visibility, user location, access permissions, preferred availability times, previous history, browsing history, stored interests, stored profiles, stored preferences, stored query parameters, comments of activity by others, shares of activities by others, tags of activities by others, prior activity success, activity ratings as given by an individual user or group, activity provider ratings as given by an individual user or group, on-page filters, search queries, other user's activity reviews and feedback, shared activity liked content, shared activity uploads and tagged promotional files, attendance histories, activity popularity, published event RSVP attendance and published possible wait times; and
a dynamic parameter; wherein a dynamic parameter may be one among said user's current geo-positioning coordinates, relative positions of each user as part of a closed user group that wants to attend or join the activity as a group, proximity of the said user to the activities surrounding said user, said user's desired search radius, new activities being posted in real-time providing more options, existing user's schedule, modified activity data, traffic conditions that affect a user's arrival at an activity, unpredictable weather patterns that affect the event launch, blocks of activity time changes affecting an itinerary, sudden spike in attendance because of a deadline, floods of last minute reservations that lead to late RSVPs, extensive wait times that conflict with the user's preferred time schedule or the schedule of the group.

33) The method as in claim 32, wherein an activity provider may be a user operating in capacity of a moderator, team leader, host, manager, dispatcher, director, organizer, planner, promoter, coordinator, facilitator, instructor or point of contact for an activity.

34) The method as in claim 32 wherein schedule may be one of an organized collection of time and date sensitive activities, which may comprise a daily, weekly, or monthly calendar, activity calendar, meeting calendar, to-do list, task-tracking chart, travel itinerary, agenda, project-based workflow diagram, reservation wait-list or appointment docket.

35) The method as in claim 25, wherein executing said user selected service option may comprise:
adding or editing, using a widget(s) or plug-in(s), a new activity database record to the database;
uploading or editing, using a widget(s) or plug-in(s), an information data object;
streaming, using a widget(s) or plug-in(s), an information data object;
messaging with other users, using a widget(s) or plug-in(s), about or during an activity database record;
messaging with other users, using a widget(s) or plug-in(s), about or during an information data object;
speaking with other users, using a widget(s) or plug-in(s), about or during an activity database record;
speaking with other users, using a widget(s) or plug-in(s), or during an information data object;
viewing other users, using a widget(s) or plug-in(s), when discussing or during an activity database record;
viewing other users, using a widget(s) or plug-in(s), when discussing or during an information data object;
collaborating with other users, using a widget(s) or plug-in(s), about, on or during an activity database record;
collaborating with other users, using a widget(s) or plug-in(s), about, on or during an information data object;
sharing with other users, using a widget(s) or plug-in(s), about, on or during an activity database record; and
sharing with other users, using a widget(s) or plug-in(s), about, on or during an information data object.

36) The method as in claim 25, wherein said information data objects may be one among activity details, promotional materials, maps, blogs, images, graphics, logos, price lists, catalogs, inventory sheets, site plans, videos, files, bookmarks, live streaming content, text, audio files, calendars, menus and schedules.
